(19) United States
(12) Patent Application Publication
(10) Pub. No.: US 2025/0234388 A1
(43) Pub. Date: Jul. 17, 2025

(54) METHOD AND APPARATUS FOR CHANNEL MONITORING IN A WIRELESS COMMUNICATION SYSTEM

(71) Applicant: ASUS Technology Licensing Inc., Taipei City (TW)

(72) Inventors: Yi-Hsuan Huang, Taipei City (TW); Meng-Hui Ou, Taipei City (TW); Yu-Hsuan Guo, Taipei City (TW); Ming-Che Li, Taipei City (TW)

(21) Appl. No.: 19/014,080

(22) Filed: Jan. 8, 2025

Related U.S. Application Data
(60) Provisional application No. 63/620,679, filed on Jan. 12, 2024.
(60) Provisional application No. 63/563,235, filed on Mar. 8, 2024.

(51) Int. Cl. H04W 74/0833; H04L 43/0852; H04W 76/38

(52) U.S. Cl. CPC H04W 74/0833; H04L 43/0852; H04W 76/38

(57) ABSTRACT

Methods, systems, and apparatuses are provided for channel monitoring in a wireless communication system, wherein a method of a User Equipment (UE) comprises receiving a first signaling of triggering a random access procedure, triggering the random access procedure, in response to (receiving) the first signaling, transmitting a first transmission during the random access procedure, determining a third timing based on at least a first timing and a first time delay, wherein the first timing is an end of the first signaling, and monitoring a second transmission starting from the third timing, in response to transmitting the first transmission.

### CROSS-REFERENCE TO RELATED APPLICATIONS

The present Application claims priority to and the benefit of U.S. Provisional Patent Application Ser. No. 63/620,679, filed Jan. 12, 2024, and U.S. Provisional Patent Application Ser. No. 63/563,235, filed Mar. 8, 2024; with each of the listed and referenced applications and disclosures fully incorporated herein by reference.

### FIELD

This disclosure generally relates to wireless communication networks and, more particularly, to a method and apparatus for channel monitoring in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

Methods, systems, and apparatuses are provided for channel monitoring in a wireless communication system. Ambient Internet of Things (IoT) User Equipment (UE) could properly perform initial access and reduce power consumption. The multiple ambient UEs could monitor a network response at a (common) start time determined based on the triggering signaling, wherein the triggering signaling indicates the multiple UEs to trigger random access.

In various embodiments, a method of a UE in a wireless communication system comprises receiving a first signaling of triggering a random access procedure, triggering the random access procedure, in response to (receiving) the first signaling, transmitting a first transmission during the random access procedure, determining a third timing based on at least a first timing and a first time delay, wherein the first timing is an end of the first signaling, and monitoring a second transmission starting from the third timing, in response to transmitting the first transmission.

In various embodiments, a method of a UE in a wireless communication system comprises receiving a first signaling of triggering a random access procedure, triggering the random access procedure, in response to (receiving) the first signaling, transmitting a first transmission during the random access procedure, determining a third timing based on at least a second timing and a second time delay, wherein the second timing is an end of the first transmission and the second time delay is derived or calculated by the UE, and monitoring a second transmission starting from the third timing, in response to transmitting the first transmission.

In various embodiments, a method of a reader in a wireless communication system comprises transmitting a first signaling of triggering one or more random access procedures for more than one UE, receiving at least one first transmission from at least one UE of the more than one UE, in response to (transmitting) the first signaling, and transmitting at least one second transmission for the at least the one UE after or upon a third timing, in response to (receiving) the at least one first transmission, wherein the third timing is common for the more than one UE.

### BRIEF DESCRIPTION OF THE DRAWINGS

FIG. 1 shows a diagram of a wireless communication system, in accordance with embodiments of the present invention.

FIG. 2 is a block diagram of a transmitter system (also known as access network) and a receiver system (also known as user equipment or UE), in accordance with embodiments of the present invention.

FIG. 3 is a functional block diagram of a communication system, in accordance with embodiments of the present invention.

FIG. 4 is a functional block diagram of the program code of FIG. 3, in accordance with embodiments of the present invention.

FIG. 5 is a reproduction of FIG. 4.2.1.1-1: Topology 1, from 3GPP TR 38.848 V18.0.0.

FIG. 6 is a reproduction of FIG. 4.2.1.2-1: Topology 2, from 3GPP TR 38.848 V18.0.0.

FIG. 7A is a reproduction of FIG. 9.2.6-1(a): Random Access Procedures, CBRA with 4-step RA type, from 3GPP TS 38.300 V17.6.0.

FIG. 7B is a reproduction of FIG. 9.2.6-1(b): Random Access Procedures, CBRA with 2-step RA type, from 3GPP TS 38.300 V17.6.0.

FIG. 7C is a reproduction of FIG. 9.2.6-1(c): Random Access Procedures, CFRA with 4-step RA type, from 3GPP TS 38.300 V17.6.0.

FIG. 7D is a reproduction of FIG. 9.2.6-1(d): Random Access Procedures, CFRA with 2-step RA type, from 3GPP TS 38.300 V17.6.0.

FIG. 8 is a reproduction of FIG. 9.2.6-2: Fallback for CBRA with 2-step RA type, from 3GPP TS 38.300 V17.6.0.

FIG. 9 is an example diagram showing that a UE may receive a first signaling to trigger a random access procedure and transmit a first transmission (e.g., Msg1) in the random access procedure, and the UE may determine a start time (e.g., third timing) to monitor a second transmission (e.g., Msg2) based on: a first timing of receiving the first signaling and time delay, or a second timing of transmitting the first transmission and time delay, in accordance with embodiments of the present invention.

FIG. 10 is a flow diagram of a method of a UE in a wireless communication system comprising initiating an RA procedure, in the RA procedure, transmitting a message including an identity of the UE, receiving a channel transmission in response to transmitting the message, and determining the RA procedure is successfully completed based on the channel transmission scrambling with the identity of the UE or the channel transmission indicating the identity of the UE.

FIG. 11 is a flow diagram of a method of a UE in a wireless communication system comprising initiating an RA procedure, in the RA procedure, transmitting a first message including an identity of the UE, receiving a second message in response to transmitting the first message, and determining the RA procedure is successfully completed based on the second message indicating the identity of the UE.

FIG. 12 is a flow diagram of a method of a UE in a wireless communication system comprising receiving a signaling from a NW, initiating a RA procedure in response to (receiving) the signaling, transmitting a first message, starting a first timer at a specific timing, monitoring channel when the first timer is running, and receiving a second message on the channel in response to transmitting the first message.

FIG. 13 is a flow diagram of a method of a UE in a wireless communication system comprising receiving a first signaling of triggering a random access procedure, triggering the random access procedure, in response to (receiving) the first signaling, transmitting a first transmission during the random access procedure, determining a third timing based on at least a first timing and a first time delay, and monitoring a second transmission starting from the third timing, in response to transmitting the first transmission.

FIG. 14 is a flow diagram of a method of a UE in a wireless communication system comprising receiving a first signaling of triggering a random access procedure, triggering the random access procedure, in response to (receiving) the first signaling, transmitting a first transmission during the random access procedure, determining a third timing based on at least a second timing and a second time delay, and monitoring a second transmission starting from the third timing, in response to transmitting the first transmission.

FIG. 15 is a flow diagram of a method of a reader in a wireless communication system comprising transmitting a first signaling of triggering one or more random access procedures for more than one UE, receiving at least one first transmission from at least one UE of the more than one UE, in response to (transmitting) the first signaling, and transmitting at least one second transmission for the at least one UE after a third timing, in response to (receiving) the at least one first transmission.

### DETAILED DESCRIPTION

The invention described herein can be applied to or implemented in exemplary wireless communication systems and devices described below. In addition, the invention is described mainly in the context of the 3GPP architecture reference model. However, it is understood that with the disclosed information, one skilled in the art could easily adapt for use and implement aspects of the invention in a 3GPP2 network architecture as well as in other network architectures.

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A (Long Term Evolution Advanced) wireless access, 3GPP2 UMB (Ultra Mobile Broadband), WIMAX®, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: [1] RP-234058, “Study on solutions for Ambient IoT (Internet of Things) in NR.”; [2] 3GPP TR 38.848 V18.0.0 (2023 September) 3GPP; TSG RAN; Study on Ambient IoT (Internet of Things) in RAN (Release 18); [3] 3GPP TS 38.321 V17.6.0 (2023 September) 3GPP; TSG RAN; NR; MAC protocol specification (Release 17); [4] 3GPP TS 38.300 V17.6.0 (2023 September) 3GPP; TSG RAN; NR; NR and NG-RAN Overall Description (Release 17); and [5] 3GPP TS 38.213 V17.7.0 (2023 September) 3GPP; TSG RAN; NR; Physical layer procedures for control (Release 17). The standards and documents listed above are hereby expressly and fully incorporated herein by reference in their entirety.

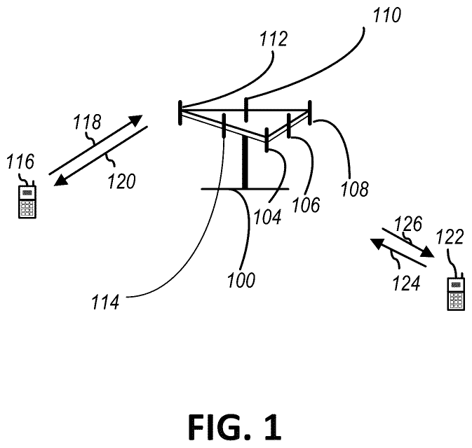

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal (AT) 116 is in communication with antennas 112 and 114, where antennas 112 and 114 transmit information to access terminal 116 over forward link 120 and receive information from AT 116 over reverse link 118. AT 122 is in communication with antennas 106 and 108, where antennas 106 and 108 transmit information to AT 122 over forward link 126 and receive information from AT 122 over reverse link 124. In a FDD system, communication links 118, 120, 124 and 126 may use different frequency for communication. For example, forward link 120 may use a different frequency than that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage normally causes less interference to access terminals in neighboring cells than an access network transmitting through a single antenna to all its access terminals.

The AN may be a fixed station or base station used for communicating with the terminals and may also be referred to as an access point, a Node B, a base station, an enhanced base station, an eNodeB, or some other terminology. The AT may also be called User Equipment (UE), a wireless communication device, terminal, access terminal or some other terminology.

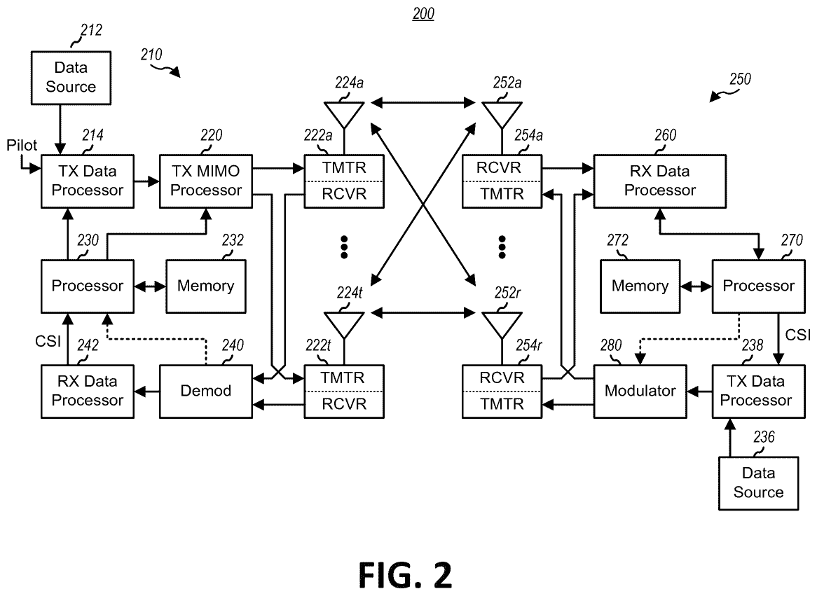

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230. A memory 232 is coupled to processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T}“detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

Memory 232 may be used to temporarily store some buffered/computational data from 240 or 242 through Processor 230, store some buffed data from 212, or store some specific program codes. And Memory 272 may be used to temporarily store some buffered/computational data from 260 through Processor 270, store some buffed data from 236, or store some specific program codes.

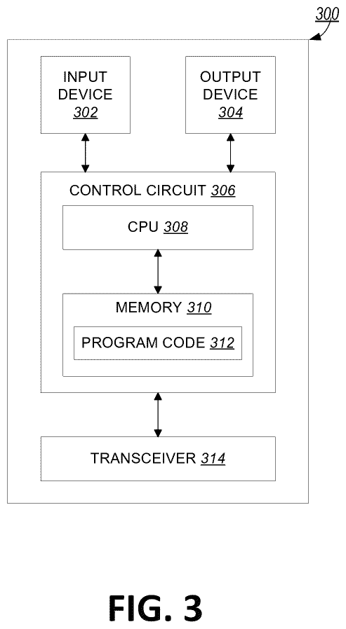

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

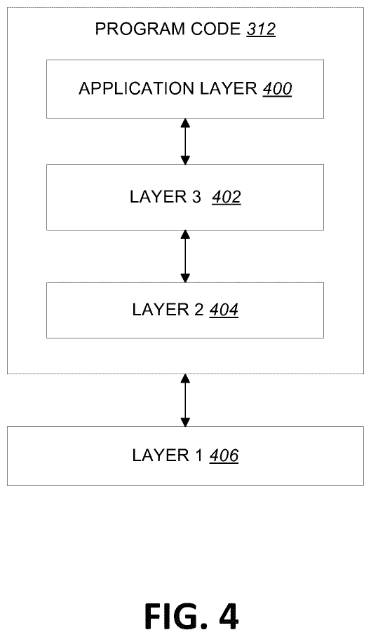

FIG. 4 is a simplified block diagram of the program code 312 shown in FIG. 3 in accordance with an embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE, LTE-A, or NR systems, the Layer 2 portion 404 may include a Radio Link Control (RLC) layer and a Medium Access Control (MAC) layer. The Layer 3 portion 402 may include a Radio Resource Control (RRC) layer.

Any two or more than two of the following paragraphs, (sub-)bullets, points, actions, or claims described in each invention paragraph or section may be combined logically, reasonably, and properly to form a specific method.

Any sentence, paragraph, (sub-)bullet, point, action, or claim described in each of the following invention paragraphs or sections may be implemented independently and separately to form a specific method or apparatus. Dependency, e.g., “based on”, “more specifically”, “example”, etc., in the following invention disclosure is just one possible embodiment which would not restrict the specific method or apparatus.

The study item of ambient Internet of Things (IoT) has been approved in RAN plenary #102 meeting. The description is specified in [1] RP-234058, as below:

### Quotation Start [1]

### 3 Justification

In recent years, IoT has attracted much attention in the wireless communication world. More ‘things’ are expected to be interconnected for improving productivity efficiency and increasing comforts of life. Further reduction of size, complexity, and power consumption of IoT devices can enable the deployment of tens or even hundreds of billion IoT devices for various applications and provide added value across the entire value chain. It is impossible to power all the IoT devices by battery that needs to be replaced or recharged manually, which leads to high maintenance cost, serious environmental issues, and even safety hazards for some use cases (e.g., wireless sensor in electric power and petroleum industry).

Most of the existing wireless communication devices are powered by battery that needs to be replaced or recharged manually. The automation and digitalization of various industries open numbers of new markets requiring new IoT technologies of supporting batteryless devices with no energy storage capability or devices with energy storage that do not need to be replaced or recharged manually. The form factor of such devices must be reasonably small to convey the validity of target use cases.

TR 22.840 is being developed by SA1 to capture use cases, traffic scenarios, device constraints of ambient power-enabled Internet of Things and identify new potential service requirements as well as new KPIs. SA1 are considering devices being either battery-less or with limited energy storage capability (i.e., using a capacitor) and the energy is provided through the harvesting of radio waves, light, motion, heat, or any other power source that could be seen suitable.

Considering the limited size and complexity required by practical applications for batteryless devices with no energy storage capability or devices with limited energy storage that do not need to be replaced or recharged manually, the output power of energy harvester is typically from 1 μW to a few hundreds of μW. Existing cellular devices may not work well with energy harvesting due to their peak power consumption of higher than 10 mW.

An example type of application in TR 22.840 is asset identification, which presently has to resort mainly to barcode and RFID in most industries. The main advantage of these two technologies is the ultra-low complexity and small form factor of the tags. However, the limited reading range of a few meters usually requires handheld scanning which leads to labor intensive and time-consuming operations, or RFID portals/gates which leads to costly deployments. Moreover, the lack of interference management scheme results in severe interference between RFID readers and capacity problems, especially in case of dense deployment. It is hard to support large-scale network with seamless coverage for RFID.

TSG RAN has completed a Rel-18 RAN-level SI on Ambient IoT, which provides a terminological and scoping framework for future discussions of Ambient IoT. This has defined representative use cases, deployment scenarios, connectivity topologies, Ambient IoT devices, design targets, and required functionalities; it also conducted a preliminary feasibility assessment, and gave recommendations for down-selection in setting the scope of a further WG-level study.

Since existing technologies cannot meet all the requirements of target use cases, a new IoT technology is recommended to open new markets within 3GPP systems, whose number of connections and/or device density can be orders of magnitude higher than existing 3GPP IoT technologies. The new IoT technology shall provide complexity and power consumption orders of magnitude lower than the existing 3GPP LPWA technologies (e.g. NB-IoT and eMTC), and shall address use cases and scenarios that cannot otherwise be fulfilled based on existing 3GPP LPWA IoT technologies.

### 4 Objective

### 4.1 Objective of SI or Core part WI or Testing part WI

This study targets a further assessment at RAN WG-level of Ambient IoT, a new 3GPP IoT technology, suitable for deployment in a 3GPP system, which relies on ultra-low complexity devices with ultra-low power consumption for the very-low end IoT applications. The study shall provide clear differentiation, i.e. addressing use cases and scenarios that cannot otherwise be fulfilled based on existing 3GPP LPWA IoT technology e.g. NB-IoT including with reduced peak Tx power.

### General Scope

The definitions provided in TR 38.848 are taken into this SI, and the following are the exclusive general scope:
A. The overall objective shall be to study a harmonized air interface design with minimized differences (where necessary) for Ambient IoT to enable the following devices:
   i. ˜1 μW peak power consumption, has energy storage, initial sampling frequency offset (SFO) up to 10^{X} ppm, neither DL nor UL amplification in the device. The device's UL transmission is backscattered on a carrier wave provided externally.
   ii. ≤a few hundred μW peak power consumption¹, has energy storage, initial sampling frequency offset (SFO) up to 10^{X} ppm, both DL and/or UL amplification in the device. The device's UL transmission may be generated internally by the device, or be backscattered on a carrier wave provided externally.
   X is to be decided in WGs.
   Coverage design target: Maximum distance of 10-50 m with device indoors as per TR 38.848: “. . . a range that WGs can sub-select within”.
   For Topologies 1 & 2 (UE as intermediate node under NW control) per TR 38.848, with no RRC states, no mobility (i.e. at least no cell selection/re-selection-like function), no HARQ, no ARQ.
NOTE 1: It is to be understood that “≤a few hundred μW” means WGs are not tasked with setting a particular value, and that it will be for WG discussions to determine if a presented design with corresponding power consumption satisfies the “≤ a few hundred μW” requirement.
B. Deployment Scenarios with the following characteristics, referenced to the tables in Clause 4.2.2 of TR 38.848:
   Deployment scenario 1 with Topology 1
      Basestation and coexistence characteristics: Micro-cell, co-site
   Deployment scenario 2 with Topology 2 and UE as intermediate node, under network control
      Basestation and coexistence characteristics: Macro-cell, co-site
      The location of intermediate node is indoor
C. FR1 licensed spectrum in FDD.
D. Spectrum deployment in-band to NR, in guard-band to LTE/NR, in standalone band(s).
E. Traffic types DO-DTT, DT, with focus on rUC1 (indoor inventory) and rUC4 (indoor command).
   From RAN #104, the study will assess whether the harmonized air interface design (per bullet ‘A’ above) can address the DO-A (Device-originated autonomous) use case, only to identify which part(s) of the harmonized air interface design (per bullet ‘A’ above) is/are not sufficient for the DO-A use case.

Transmission from Ambient IoT device (including backscattering when used) can occur at least in UL spectrum.

The following objectives are set, within the General Scope:
. . .
1. Study necessary and feasible solutions for Ambient IoT as prescribed in the General Scope, including decisions on which functions, procedures, etc. are needed and not needed, and ensuring at least the required functionalities in Section 6.2 of TR 38.848.
. . .
   RAN1-led:
      For the Ambient IoT DL and UL:
         Frame structure, synchronization and timing, random access
         Numerologies, bandwidths, and multiple access
         Waveforms and modulations
         Channel coding
         Downlink channel/signal aspects
         Uplink channel/signal aspects
         Scheduling and timing relationships
         Study necessary characteristics of carrier-wave waveform for a carrier wave provided externally to the Ambient IoT device, including for interference handling at Ambient IoT UL receiver, and at NR basestation.
         For Topology 2, no difference in physical layer design from Topology 1.
   RAN2-led:
      Study and decide which functions are needed for an Ambient IoT compact protocol stack and lightweight signalling procedure to enable DO-DTT and DT data transmission, and study those functions.
         For example: Paging Random access Data transmission, including necessary radio resource control aspects, respecting the limitation in the General Scope

### Quotation End

The description (e.g. regarding topology and assumption) for ambient IoT can be found in [2] 3GPP TR 38.848 V18.0.0 (2023-09).

### Quotation Start [2]

### 4.2.1 Connectivity Topologies

### 4.2.1.0 Introduction

The following connectivity topologies for Ambient IoT networks and devices are defined for the purposes of the study. In all these topologies, the Ambient IoT device may be provided with a carrier wave from other node(s) either inside or outside the topology. The links in each topology may be bidirectional or unidirectional.

BS, UE, assisting node, or intermediate node could be multiple BSs or UEs, respectively. The mixture of indoor and outdoor placement of such nodes is regarded as a network implementation choice. Account would need to be taken of potential impact on device or node complexity. In the connectivity topologies, this does not imply the existence of multi-hop assisting or intermediate nodes.

### 4.2.1.1 Topology 1: BS↔Ambient IoT Device

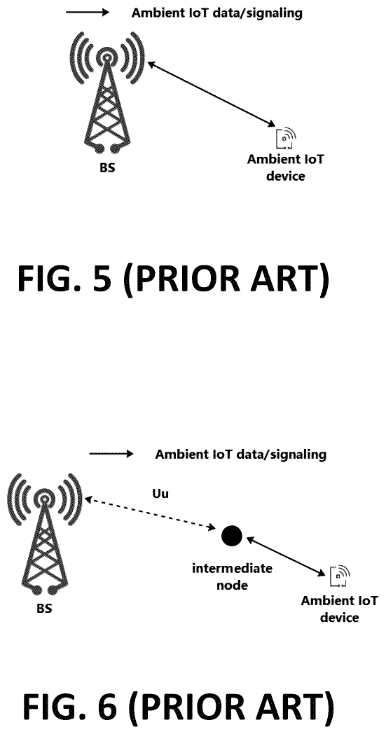

### FIG. 5 is a Reproduction of FIG. 4.2.1.1-1: Topology 1, from 3GPP TR 38.848 V18.0.0

In Topology 1, the Ambient IoT device directly and bidirectionally communicates with a basestation. The communication between the basestation and the ambient IoT device includes Ambient IoT data and/or signalling. This topology includes the possibility that the BS transmitting to the Ambient IoT device is a different from the BS receiving from the Ambient IoT device.

### 4.2.1.2 Topology 2: BS↔intermediate Node↔Ambient IoT Device

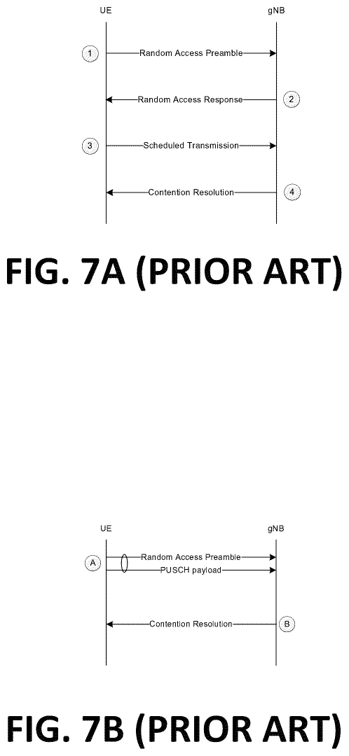

### FIG. 6 is a Reproduction of FIG. 4.2.1.2-1: Topology 2, from 3GPP TR 38.848 V18.0.0

In Topology 2, the Ambient IoT device communicates bidirectionally with an intermediate node between the device and basestation. In this topology, the intermediate node can be a relay, IAB node, UE, repeater, etc. which is capable of Ambient IoT. The intermediate node transfers Ambient IoT data and/or signalling between BS and the Ambient IoT device.

### Next Quotation

### 4.3 Device Categorization

Ambient IoT devices are characterized in the study according to their energy storage capacity, and capability of generating RF signals for their transmissions.

The study considers that a device has either:
No energy storage at all; or
Limited energy storage

Relying on these storage capacities, the study considers the following set of Ambient IoT devices:
Device A: No energy storage, no independent signal generation/amplification, i.e. backscattering transmission.
Device B: Has energy storage, no independent signal generation, i.e. backscattering transmission. Use of stored energy can include amplification for reflected signals.
Device C: Has energy storage, has independent signal generation, i.e., active RF components for transmission.

A limited energy storage can be different among implementations within Device B or implementations within Device C, and different between Device B and Device C. Such storage is expected to be order(s) of magnitude smaller than an NB-IoT device would typically include.

### Quotation End

The current random access (RA) procedure handling is specified in [3] 3GPP TS 38.321 V17.6.0 (2023-09). The (current) RA procedure would be performed by a legacy UE. An ambient IoT UE would perform (part of) the current RA procedure.

### Quotation Start [3]

### 5.1 Random Access Procedure

### 5.1.1 Random Access Procedure Initialization

The Random Access procedure described in this clause is initiated by a PDCCH order, by the MAC entity itself, or by RRC for the events in accordance with TS 38.300 [4]. There is only one Random Access procedure ongoing at any point in time in a MAC entity. The Random Access procedure on an SCell shall only be initiated by a PDCCH order with ra-PreambleIndex different from 0b000000.

When a Random Access procedure is initiated, UE selects a set of Random Access resources as specified in clause 5.1.1b and initialises the following parameters for the Random Access procedure according to the values configured by RRC for the selected set of Random Access resources:
prach-ConfigurationIndex: the available set of PRACH occasions for the transmission of the Random Access Preamble for Msg1. These are also applicable to the MSGA PRACH if the PRACH occasions are shared between 2-step and 4-step RA types;
. . .
msgA-PRACH-ConfigurationIndex: the available set of PRACH occasions for the transmission of the Random Access Preamble for MSGA in 2-step RA type;
. . .
ra-PreambleIndex: Random Access Preamble;
ra-ssb-OccasionMaskIndex: defines PRACH occasion(s) associated with an SSB in which the MAC entity may transmit a Random Access Preamble (see clause 7.4);
msgA-SSB-SharedRO-MaskIndex: Indicates the subset of 4-step RA type PRACH occasions shared with 2-step RA type PRACH occasions for each SSB. If 2-step RA type PRACH occasions are shared with 4-step RA type PRACH occasions and msgA-SSB-SharedRO-MaskIndex is not configured, then all 4-step RA type PRACH occasions are available for 2-step RA type (see clause 7.4);
ssb-SharedRO-MaskIndex: defines PRACH occasions, on which preambles are allocated for a feature or a combination of features, associated with an SSB in which the MAC entity may transmit a Random Access Preamble (see clause 7.4);
ra-OccasionList: defines PRACH occasion(s) associated with a CSI-RS in which the MAC entity may transmit a Random Access Preamble;
ra-PreambleStartIndex: the starting index of Random Access Preamble(s) for on-demand SI request;
startPreamble ForThisPartition: the first preamble associated with the set of Random Access Resources applicable to the Random Access procedure;
preambleTransMax: the maximum number of Random Access Preamble transmission;
. . .
the set of Random Access Preambles and/or PRACH occasions for SI request, if any;
the set of Random Access Preambles and/or PRACH occasions for beam failure recovery request, if any;
the set of Random Access Preambles and/or PRACH occasions for reconfiguration with sync, if any;
ra-Response Window: the time window to monitor RA response(s) (SpCell only);
ra-ContentionResolution Timer: the Contention Resolution Timer (SpCell only);
msgB-ResponseWindow: the time window to monitor RA response(s) for 2-step RA type (SpCell only).
. . .

When the Random Access procedure is initiated on a Serving Cell, the MAC entity shall:
. . .
1> select the set of Random Access resources applicable to the current Random Access procedure according to clause 5.1.1b;
1> if the Random Access procedure is initiated by PDCCH order and if the ra-PreambleIndex explicitly provided by PDCCH is not 0b000000; or
1> if the Random Access procedure was initiated for SI request (as specified in TS 38.331) and the Random Access Resources for SI request have been explicitly provided by RRC; or
1> if the Random Access procedure was initiated for SpCell beam failure recovery (as specified in clause 5.17) and if the contention-free Random Access Resources for beam failure recovery request for 4-step RA type have been explicitly provided by RRC for the BWP selected for Random Access procedure; or
1> if the Random Access procedure was initiated for reconfiguration with sync and if the contention-free Random Access Resources for 4-step RA type have been explicitly provided in rach-ConfigDedicated for the BWP selected for Random Access procedure:
   2> set the RA_TYPE to 4-stepRA.
1> else if the BWP selected for Random Access procedure is configured with both 2-step and 4-step RA type Random Access Resources within the selected set of Random Access resources (as specified in clause 5.1.1b) and the RSRP of the downlink pathloss reference is above msgA-RSRP-Threshold; or
1> if the BWP selected for Random Access procedure is only configured with 2-step RA type Random Access resources within the selected set of Random Access resources according to clause 5.1.1b; or
1> if the Random Access procedure was initiated for reconfiguration with sync and if the contention-free Random Access Resources for 2-step RA type have been explicitly provided in rach-ConfigDedicated for the BWP selected for Random Access procedure:
   2> set the RA_TYPE to 2-stepRA.
1> else:
   2> set the RA_TYPE to 4-stepRA.
1> perform initialization of variables specific to Random Access type as specified in clause 5.1.1a;
1> if RA_TYPE is set to 2-stepRA:
2> perform the Random Access Resource selection procedure for 2-step RA type (see clause 5.1.2a).
1> else:
   2> perform the Random Access Resource selection procedure (see clause 5.1.2).

### 5.1.2 Random Access Resource Selection

If the selected RA_TYPE is set to 4-stepRA, the MAC entity shall:
. . .
   2> select a Random Access Preamble randomly with equal probability from the Random Access Preambles associated with the selected SSB and the selected Random Access Preambles group;
   2> set the PREAMBLE_INDEX to the selected Random Access Preamble.
. . .
1> else if an SSB is selected above:
   2> determine the next available PRACH occasion from the PRACH occasions corresponding to the selected SSB permitted by the restrictions given by the ra-ssb-OccasionMaskIndex if configured, or ssb-SharedRO-MaskIndex if configured, or indicated by PDCCH (the MAC entity shall select a PRACH occasion randomly with equal probability amongst the consecutive PRACH occasions according to clause 8.1 of TS 38.213 [5] regardless the FR2 UL gap, corresponding to the selected SSB; the MAC entity may take into account the possible occurrence of measurement gaps and MUSIM gaps when determining the next available PRACH occasion corresponding to the selected SSB).
1> else if a CSI-RS is selected above:
   2> if there is no contention-free Random Access Resource associated with the selected CSI-RS:
      3> determine the next available PRACH occasion from the PRACH occasions, permitted by the restrictions given by the ra-ssb-OccasionMaskIndex if configured, corresponding to the SSB in candidateBeamRSList which is quasi-colocated with the selected CSI-RS as specified in TS 38.214 (the MAC entity shall select a PRACH occasion randomly with equal probability amongst the consecutive PRACH occasions according to clause 8.1 of TS 38.213 [5] regardless the FR2 UL gap, corresponding to the SSB which is quasi-colocated with the selected CSI-RS; the MAC entity may take into account the possible occurrence of measurement gaps and MUSIM gaps when determining the next available PRACH occasion corresponding to the SSB which is quasi-colocated with the selected CSI-RS).
   2> else:
      3> determine the next available PRACH occasion from the PRACH occasions in ra-OccasionList corresponding to the selected CSI-RS (the MAC entity shall select a PRACH occasion randomly with equal probability amongst the PRACH occasions occurring simultaneously but on different subcarriers regardless the FR2 UL gap, corresponding to the selected CSI-RS; the MAC entity may take into account the possible occurrence of measurement gaps and MUSIM gaps when determining the next available PRACH occasion corresponding to the selected CSI-RS).
1> perform the Random Access Preamble transmission procedure (see clause 5.1.3).
. . .

### 5.1.2a Random Access Resource Selection for 2-Step RA Type

If the selected RA_TYPE is set to 2-stepRA, the MAC entity shall:
. . .
   2> select a Random Access Preamble randomly with equal probability from the 2-step RA type Random Access Preambles associated with the selected SSB and the selected Random Access Preambles group;
   2> set the PREAMBLE_INDEX to the selected Random Access Preamble.
1> determine the next available PRACH occasion from the PRACH occasions corresponding to the selected SSB permitted by the restrictions given by the msgA-SSB-SharedRO-MaskIndex if configured, or ra-ssb-OccasionMaskIndex if configured, or ssb-SharedRO-MaskIndex if configured (the MAC entity shall select a PRACH occasion randomly with equal probability among the consecutive PRACH occasions allocated for 2-step RA type according to clause 8.1 of TS 38.213 [5] regardless the FR2 UL gap, corresponding to the selected SSB; the MAC entity may take into account the possible occurrence of measurement gaps and MUSIM gaps when determining the next available PRACH occasion corresponding to the selected SSB);
1> if the Random Access Preamble was not selected by the MAC entity among the contention-based Random Access Preamble(s):
   2> select a PUSCH occasion from the PUSCH occasions configured in msgA-CFRA-PUSCH corresponding to the PRACH slot of the selected PRACH occasion, according to msgA-PUSCH-Resource-Index corresponding to the selected SSB;
   2> determine the UL grant and the associated HARQ information for the MSGA payload in the selected PUSCH occasion;
   2> deliver the UL grant and the associated HARQ information to the HARQ entity.
1> else:
   2> select a PUSCH occasion corresponding to the selected preamble and PRACH occasion according to clause 8.1A of TS 38.213 [5];
   2> determine the UL grant for the MSGA payload according to the PUSCH configuration associated with the selected Random Access Preambles group and determine the associated HARQ information;
   2> if the selected preamble and PRACH occasion is mapped to a valid PUSCH occasion as specified in clause 8.1A of TS 38.213 [5]:
      3> deliver the UL grant and the associated HARQ information to the HARQ entity.
1> perform the MSGA transmission procedure (see clause 5.1.3a).

### 5.1.3 Random Access Preamble Transmission

The MAC entity shall, for each Random Access Preamble:
. . .
1> instruct the physical layer to transmit the Random Access Preamble using the selected PRACH occasion, corresponding RA-RNTI (if available), PREAMBLE_INDEX, and PREAMBLE_RECEIVED_TARGET_POWER.
. . .

### 5.1.3a MSGA Transmission

The MAC entity shall, for each MSGA:
. . .
1> instruct the physical layer to transmit the MSGA using the selected PRACH occasion and the associated PUSCH resource of MSGA (if the selected preamble and PRACH occasion is mapped to a valid PUSCH occasion), using the corresponding RA-RNTI, MSGB-RNTI, PREAMBLE_INDEX, PREAMBLE_RECEIVED_TARGET_POWER, msgA-PreambleReceivedTargetPower, and the amount of power ramping applied to the latest MSGA preamble transmission (i.e. (PREAMBLE_POWER_RAMPING_COUNTER−1)×PREAMBLE_POWER_RAMPING_STEP);
. . .

### 5.1.4 Random Access Response Reception

Once the Random Access Preamble is transmitted and regardless of the possible occurrence of a measurement gap, the MAC entity shall:
1> if the contention-free Random Access Preamble for beam failure recovery request was transmitted by the MAC entity:
   2> if the contention-free Random Access Preamble for beam failure recovery request was transmitted on a non-terrestrial network:
      3> start the ra-Response Window configured in BeamFailureRecoveryConfig at the PDCCH occasion as specified in TS 38.213 [5].
   2> else:
      3> start the ra-Response Window configured in BeamFailureRecoveryConfig at the first PDCCH occasion as specified in TS 38.213 [5] from the end of the Random Access Preamble transmission.
   2> monitor for a PDCCH transmission on the search space indicated by recoverySearchSpaceId of the SpCell identified by the C-RNTI while ra-ResponseWindow is running.
1> else:
. . .
   3> start the ra-Response Window configured in RACH-ConfigCommon at the first PDCCH occasion as specified in TS 38.213 [5] from the end of the Random Access Preamble transmission.
   2> monitor the PDCCH of the SpCell for Random Access Response(s) identified by the RA-RNTI while the ra-ResponseWindow is running.
. . .

### 5.1.4a MSGB Reception and Contention Resolution for 2-Step RA Type

Once the MSGA preamble is transmitted, regardless of the possible occurrence of a measurement gap, the MAC entity shall:
1> start the msgB-ResponseWindow at the PDCCH occasion as specified in TS 38.213 [5], clause 8.2A;
1> monitor the PDCCH of the SpCell for a Random Access Response identified by MSGB-RNTI while the msgB-ResponseWindow is running;
1> if C-RNTI MAC CE was included in the MSGA:
   2> monitor the PDCCH of the SpCell for Random Access Response identified by the C-RNTI while the msgB-ResponseWindow is running.

### 6.1.5 MAC PDU (Random Access Response)

A MAC PDU consists of one or more MAC subPDUs and optionally padding. Each MAC subPDU consists one of the following:
a MAC subheader with Backoff Indicator only;
a MAC subheader with RAPID only (i.e. acknowledgment for SI request);
a MAC subheader with RAPID and MAC RAR.

### Quotation End

The general description of random access procedure is specified in [4] 3GPP TS 38.300 V17.6.0 (2023-09):

### Quotation Start [4]

### 9.2.6 Random Access Procedure

The random access procedure is triggered by a number of events:
Initial access from RRC_IDLE;

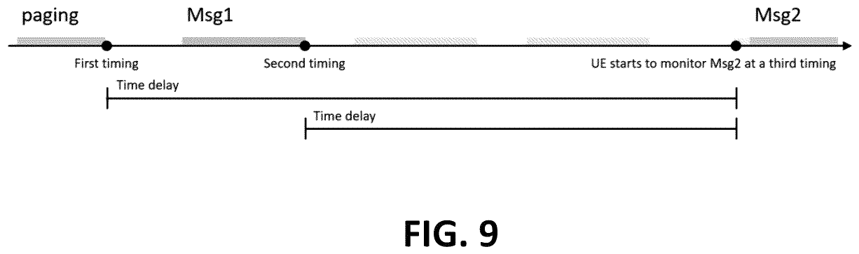

Two types of random access procedure are supported: 4-step RA type with MSG1 and 2-step RA type with MSGA. Both types of RA procedure support contention-based random access (CBRA) and contention-free random access (CFRA) as shown on FIG. 9.2.6-1 below.

The UE selects the type of random access at initiation of the random access procedure based on network configuration:
when CFRA resources are not configured, an RSRP threshold is used by the UE to select between 2-step RA type and 4-step RA type;
when CFRA resources for 4-step RA type are configured, UE performs random access with 4-step RA type;
when CFRA resources for 2-step RA type are configured, UE performs random access with 2-step RA type.
. . .

The MSG1 of the 4-step RA type consists of a preamble on PRACH. After MSG1 transmission, the UE monitors for a response from the network within a configured window. For CFRA, dedicated preamble for MSG1 transmission is assigned by the network and upon receiving random access response from the network, the UE ends the random access procedure as shown in FIG. 9.2.6-1(c). For CBRA, upon reception of the random access response, the UE sends MSG3using the UL grant scheduled in the response and monitors contention resolution as shown in FIG. 9.2.6-1(a). If contention resolution is not successful after MSG3 (re)transmission(s), the UE goes back to MSG1 transmission.

The MSGA of the 2-step RA type includes a preamble on PRACH and a payload on PUSCH. After MSGA transmission, the UE monitors for a response from the network within a configured window. For CFRA, dedicated preamble and PUSCH resource are configured for MSGA transmission and upon receiving the network response, the UE ends the random access procedure as shown in FIG. 9.2.6-1(d). For CBRA, if contention resolution is successful upon receiving the network response, the UE ends the random access procedure as shown in FIG. 9.2.6-1(b); while if fallback indication is received in MSGB, the UE performs MSG3 transmission using the UL grant scheduled in the fallback indication and monitors contention resolution as shown in FIG. 9.2.6-2. If contention resolution is not successful after MSG3 (re)transmission(s), the UE goes back to MSGA transmission.

If the random access procedure with 2-step RA type is not completed after a number of MSGA transmissions, the UE can be configured to switch to CBRA with 4-step RA type.

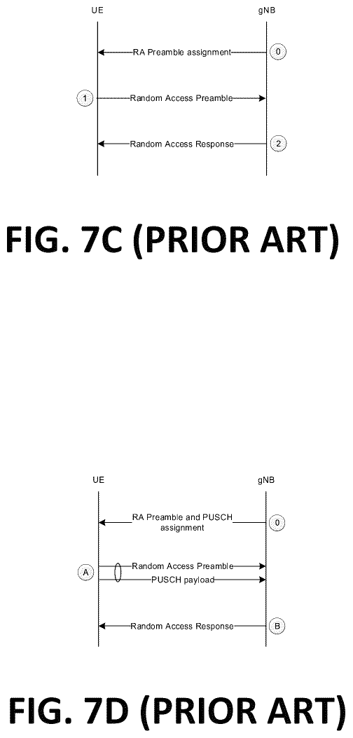

FIG. 7A is a reproduction of FIG. 9.2.6-1(a): Random Access Procedures, CBRA with 4-step RA type, from 3GPP TS 38.300 V17.6.0.

FIG. 7B is a reproduction of FIG. 9.2.6-1(b): Random Access Procedures, CBRA with 2-step RA type, from 3GPP TS 38.300 V17.6.0.

FIG. 7C is a reproduction of FIG. 9.2.6-1(c): Random Access Procedures, CFRA with 4-step RA type, from 3GPP TS 38.300 V17.6.0.

FIG. 7D is a reproduction of FIG. 9.2.6-1(d): Random Access Procedures, CFRA with 2-step RA type, from 3GPP TS 38.300 V17.6.0.

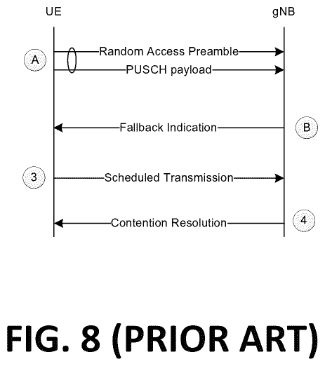

FIG. 8 is a reproduction of FIG. 9.2.6-2: Fallback for CBRA with 2-step RA type, from 3GPP TS 38.300 V17.6.0.

### Quotation End

In [5] 3GPP TS 38.213 V17.7.0 (2023-09), RA response is specified.

### Quotation [5] Start

### 8 Random Access Procedure

Prior to initiation of the physical random access procedure, Layer 1 receives from higher layers a set of SS/PBCH block indexes and provides to higher layers a corresponding set of RSRP measurements.

Prior to initiation of the physical random access procedure, Layer 1 may receive from higher layers an indication to perform a Type-1 random access procedure, as described in clauses 8.1 through 8.4, or a Type-2 random access procedure as described in clauses 8.1 through 8.2A.

Prior to initiation of the physical random access procedure, Layer 1 receives the following information from the higher layers:
Configuration of physical random access channel (PRACH) transmission parameters (PRACH preamble format, time resources, and frequency resources for PRACH transmission).
Parameters for determining the root sequences and their cyclic shifts in the PRACH preamble sequence set (index to logical root sequence table, cyclic shift (N_{CS}), and set type (unrestricted, restricted set A, or restricted set B)).

From the physical layer perspective, the Type-1 L1 random access procedure includes the transmission of random access preamble (Msg1) in a PRACH, random access response (RAR) message with a PDCCH/PDSCH (Msg2), and when applicable, the transmission of a PUSCH scheduled by a RAR UL grant, and PDSCH for contention resolution.

From the physical layer perspective, the Type-2 L1 random access procedure includes the transmission of random access preamble in a PRACH and of a PUSCH (MsgA) and the reception of a RAR message with a PDCCH/PDSCH (MsgB), and when applicable, the transmission of a PUSCH scheduled by a fallback RAR UL grant, and PDSCH for contention resolution.

If a random access procedure is initiated by a PDCCH order to the UE, a PRACH transmission is with a same SCS as a PRACH transmission initiated by higher layers.

If a UE is configured with two UL carriers for a serving cell and the UE detects a PDCCH order, the UE uses the UL/SUL indicator field value from the detected PDCCH order to determine the UL carrier for the corresponding PRACH transmission.

### 8.1 Random Access Preamble

Physical random access procedure is triggered upon request of a PRACH transmission by higher layers or by a PDCCH order. A configuration by higher layers for a PRACH transmission includes the following:
A configuration for PRACH transmission [TS 38.211].
A preamble index, a preamble SCS, P_{PRACH,target}, a corresponding RA-RNTI, and a PRACH resource.
. . .

### 8.2 Random Access Response-Type-1 Random Access Procedure

In response to a PRACH transmission, a UE attempts to detect a DCI format 1_0 with CRC scrambled by a corresponding RA-RNTI during a window controlled by higher layers [3, TS 38.321]. The window starts at the first symbol of the earliest CORESET the UE is configured to receive PDCCH for Type1-PDCCH CSS set, as defined in clause 10.1, that is at least one symbol, after the last symbol of the PRACH occasion corresponding to the PRACH transmission, where the symbol duration corresponds to the SCS for Type1-PDCCH CSS set as defined in clause 10.1. If N_{TA,adj}^{UE} or N_{TA,adj}^{common}, as defined in [TS 38.211], is not zero, the window starts after an additional T_{TA}+k_{mac} msec where T_{TA} is defined in [TS 38.211] and k_{mac} is provided by kmac or k_{mac}=0 if kmac is not provided. The length of the window in number of slots, based on the SCS for Type1-PDCCH CSS set, is provided by ra-Response Window.
. . .

### 8.2A Random Access Response—Type-2 Random Access Procedure

In response to a transmission of a PRACH and a PUSCH, or to a transmission of only a PRACH if the PRACH preamble is mapped to a valid PUSCH occasion, a UE attempts to detect a DCI format 1_0 with CRC scrambled by a corresponding MsgB-RNTI during a window controlled by higher layers [3, TS 38.321]. The window starts at the first symbol of the earliest CORESET the UE is configured to receive PDCCH for Type1-PDCCH CSS set, as defined in clause 10.1, that is at least one symbol, after the last symbol of the PUSCH occasion corresponding to the PRACH transmission, where the symbol duration corresponds to the SCS for Type1-PDCCH CSS set. If N_{TA,adj}^{UE} or N_{TA,adj}^{common}, as defined in [TS 38.211], is not zero, the window starts after an additional T_{TA}+k_{mac} msec where T_{TA} is defined in [TS 38.211] and k_{mac} is provided by k_{mac} or k_{mac}=0 if kmac is not provided. The length of the window in number of slots, based on the SCS for Type1-PDCCH CSS set, is provided by msgB-ResponseWindow.

In response to a transmission of a PRACH, if the PRACH preamble is not mapped to a valid PUSCH occasion, a UE attempts to detect a DCI format 1_0 with CRC scrambled by a corresponding MsgB-RNTI during a window controlled by higher layers [3, TS 38.321]. The window starts at the first symbol of the earliest CORESET the UE is configured to receive PDCCH for Type1-PDCCH CSS set, as defined in clause 10.1, that is at least one symbol, after the last symbol of the PRACH occasion corresponding to the PRACH transmission, where the symbol duration corresponds to the SCS for Type1-PDCCH CSS set. The length of the window in number of slots, based on the SCS for Type1-PDCCH CSS set, is provided by msgB-ResponseWindow.

### Quotation [5] End

In the 3GPP RANI #116 meeting, there are various agreements on Ambient Internet of Things (A-IoT).

For the purpose of the study, RANI uses the following terminology:
Device 1: ˜1 μW peak power consumption, has energy storage, initial sampling frequency offset (SFO) up to 10^{X} ppm, neither Downlink (DL) nor Uplink (UL) amplification in the device. The device's UL transmission is backscattered on a carrier wave provided externally.
Device 2a: ≤a few hundred μW peak power consumption, has energy storage, initial sampling frequency offset (SFO) up to 10^{X} ppm, both DL and/or UL amplification in the device. The device's UL transmission is backscattered on a carrier wave provided externally.
Device 2b: ≤a few hundred μW peak power consumption, has energy storage, initial sampling frequency offset (SFO) up to 10^{X} ppm, both DL and/or UL amplification in the device. The device's UL transmission is generated internally by the device.

From the RAN1 perspective, at least when a response is expected from multiple devices that are intended to be identified, an A-IoT contention-based access procedure initiated by the reader is used.

At least the following time domain frame structure is studied for A-IoT Reader to (Ambient IoT) Device (R2D) and (Ambient IoT) Device to A-IoT Reader (D2R) transmission.
For R2D transmission,
   An R2D timing acquisition signal (e.g., R2D preamble) is included at least for timing acquisition and for indicating the start of the R2D transmission in time domain.
For D2R transmission,
   A D2R timing acquisition signal (e.g., D2R preamble) is included at least for timing acquisition and for indicating the start of the D2R transmission in time domain.
FFS (for further study) other necessary component(s), e.g., midamble, postamble, periodic sync signal, control fields, guard period.

For ambient IoT devices, a dedicated physical broadcast channel for R2D, e.g., Physical Broadcast Channel (PBCH)-like, is not considered for study.

For ambient IoT devices, at least for R2D data transmission, a physical channel (Physical Reader (to Ambient IoT) Device Channel (PRDCH)) is studied,
System information (if defined) is transmitted on the PRDCH.
FFS whether/how control information is transmitted on the PRDCH.
Note: the naming of PRDCH is used for the sake of the study.

For ambient IoT devices, at least for D2R data transmission, a physical channel (Physical (Ambient IoT) Device (to) Reader Channel (PDRCH)) is studied along with the following,
Response transmitted from device to reader during a contention-based access procedure is transmitted on the PDRCH.

In recent years, more devices are expected to be interconnected in the wireless communication world for improving productivity, efficiency, and increasing comforts of life. However, powering all the IoT devices by battery that need to be replaced or recharged manually would lead to high maintenance cost, environmental issues, and safety hazards for some use cases, e.g., wireless sensors in electrical power. Further reduction of size, complexity, and power consumption of IoT devices can enable the deployment for various applications (e.g., automated manufacturing, smart home).

On the other hand, barcodes and Radio-frequency Identification (RFID) have limited reading range of a few meters which usually requires handheld scanning. It would lead to labor intensive and time-consuming operations. Also, the lack of an interference management scheme would result in severe interference between RFID readers and capacity problems, especially in the case of dense deployment. It is hard to support a large-scale network with seamless coverage for RFID. In contrast, study of ambient IoT investigates the feasibility of a new IoT technology within 3GPP systems.

An ambient IoT device/User Equipment (UE) would have ultra-low complexity, a very small device size, and a long life cycle. The ambient IoT device/UE would have complexity and power consumption orders of magnitude lower than the existing 3GPP Low Power Wide Area (LPWA) technologies (e.g., Narrowband Internet of Things (NB-IoT), enhanced Machine Type Communication (eMTC)). The ambient IoT device/UE may not have energy storage or may have energy storage. The energy of the ambient IoT device/UE may be provided through the harvesting of radio waves, light, motion, heat, or any other power source that could be suitable. The energy and/or power source may be provided one-shot (e.g., unexpected or aperiodically), periodically, or continuously. In one embodiment, the power/energy of the Ambient IoT device/UE may be provided from a carrier wave from the network and/or an intermediate node. In Topology 1, the Ambient IoT device/UE would directly and bidirectionally communicate with a base station. In Topology 2, the Ambient IoT device/UE would communicate bidirectionally with an intermediate node (e.g., a UE or a relay node) between the Ambient IoT device/UE and the base station. The UL transmission of the ambient IoT device/UE may be generated internally by the device/UE, or be backscattered on the carrier wave provided externally. More details regarding ambient IoT (device/UE) could be found in the study item [1] RP-234058 and [2] 3GPP TR 38.848 V18.0.0 (2023 September).

Currently, a UE would trigger a Random Access (RA) procedure for initial access to connect to the network from Radio Resource Control Idle (RRC_IDLE) state. The initial access may be an RRC establishment procedure. The UE would transmit an RRC setup request message (e.g., RRCSetupRequest) to the network. In response to transmitting the RRC setup request message (e.g., RRCSetupRequest), the UE would receive an RRC setup message (e.g., RRCSetup) from the network. The RRC setup request message (e.g., RRCSetupRequest) and RRC setup message (e.g., RRCSetup) are Common Control Channel (CCCH) messages from logical channel from Radio Link Control (RLC) layer.

However, for an ambient IoT UE, there may not be RRC procedure(s), RRC state(s) (transition), and/or upper layers (e.g., RLC layer, Packet Data Convergence Protocol (PDCP) layer, Service Data Adaptation Protocol (SDAP) layer). An ambient IoT UE may be in (RRC) idle mode, (RRC) inactive mode, and/or (RRC) connected mode. An ambient IoT UE may not be in any/one/more of (RRC) idle mode, (RRC) inactive mode, and/or (RRC) connected mode.

The UE (e.g., ambient IoT UE) may receive a signaling, e.g., via paging, System Information Block (SIB), Physical Downlink Control Channel (PDCCH) order, PRDCH, from NW. In response to (receiving) the signaling, the UE may trigger an RA procedure. The signaling may be used to trigger (or indicate) an RA procedure (or initial access) of the UE. The signaling may be used to trigger (or indicate) a transmission (or reception) of the UE. The transmission from the UE may be (or include) a backscattering transmission (or reception) or may be generated internally by the UE. The signaling may be used to provide a power source and/or energy to the UE. The signaling may be (or include) any of RRC signaling (e.g., RRC configuration message), Medium Access Control (MAC) signaling (e.g., MAC Control Element (CE)), or Physical Layer (PHY) signaling (e.g., PDCCH, DCI). The signaling may be (or include) a carrier wave (signal) and/or interrogation signal.

The signaling may be a common signaling or a dedicated signaling. The common signaling may be (or include) a cell-specific configuration. The common signaling may be (or include) a configuration common for multiple UEs, a group of UEs and/or a UE group. The common signaling may be (or include) a broadcast signaling, system information and/or paging. The dedicated signaling may be (or include) a UE-specific configuration. The dedicated signaling may be (or include) a configuration dedicated for a (single) UE. The dedicated signaling may be (or include) RRC signaling (e.g., RRC configuration message). The dedicated signaling may be (or include) MAC signaling (e.g., MAC CE). The dedicated signaling may be (or include) PHY signaling (e.g., PDCCH, Downlink Control Information (DCI)).

In the RA procedure (e.g., for ambient IoT), the UE may transmit a first transmission to the NW. The NW may transmit a second transmission to the UE in response to reception/detection of the first transmission. In response to or after transmitting the first transmission, the UE may receive a second transmission from the NW. In response to or after transmitting the first transmission, the UE may monitor the PDCCH/PRDCH during a first time duration for receiving the second transmission. In response to or after receiving the second transmission, the UE may or may not transmit a third transmission to the NW. In the case that the UE transmits the third transmission to the NW, the NW may transmit a fourth transmission to the UE in response to reception of the third transmission. In response to or after transmitting the third transmission, the UE may receive a fourth transmission from the NW. In response to or after transmitting the third transmission, the UE may monitor the PDCCH/PRDCH during a second time duration for receiving the fourth transmission.

The first transmission may be a Message 1 (Msg1) (transmission) and/or Message A (MSGA) (transmission). The first transmission may include an RA preamble transmission and/or MSGA payload transmission. Preferably in certain embodiments, the first transmission may comprise a first preamble transmission and/or a first uplink data transmission. The first transmission may include a transmission via Physical Random Access Channel (PRACH) and/or a transmission via a first Physical Uplink Shared Channel (PUSCH). Throughout the present disclosure, the “first transmission” could be replaced by a “first message”.

The second transmission may be a Message 2 (Msg2) (transmission), Random Access Response (RAR) (transmission) and/or Message B (MSGB) (transmission). A MSGB may contain a fallbackRAR (MAC sub Protocol Data Unit (subPDU)) or a successRAR (MAC subPDU). The second transmission may be a NW response to the first transmission. Preferably in certain embodiments, the second transmission may comprise a first downlink control transmission and/or a first downlink data transmission. The second transmission may comprise a control information and/or data. The second transmission may include a transmission via a first PDCCH/PRDCH and/or a first Physical Downlink Shared Channel (PDSCH). The second transmission may provide/indicate a UL grant for scheduling UL resource(s). Throughout the present disclosure, the “second transmission” could be replaced by a “second message”.

The third transmission may be a Message 3 (Msg3) (transmission). The third transmission may be uplink transmission using the UL grant/resource(s) provided/indicated by the second transmission. Preferably in certain embodiments, the third transmission may comprise a second uplink data transmission. The third transmission may include a transmission via a second PUSCH. Throughout the present disclosure, the “third transmission” could be replaced by a “third message”.

The fourth transmission may be a Message 4 (Msg4) (transmission). The fourth transmission may be a NW response to the third transmission. Preferably in certain embodiments, the fourth transmission may comprise a second downlink control transmission and/or a second downlink data transmission. The fourth transmission may include a transmission via a second PDCCH/PRDCH and/or a transmission via a second PDSCH. Throughout the present disclosure, the “fourth transmission” could be replaced by a “fourth message”.

Throughout the present disclosure, a UL transmission may be or include a first transmission, a third transmission, and/or a subsequent UL transmission. The UL transmission may be or include a Physical Uplink Control Channel (PUCCH), PDRCH, and/or PUSCH transmission. The subsequent UL transmission may be a UL transmission after the first transmission or third transmission. The subsequent UL transmission may be a UL transmission after an RA procedure is completed. Throughout the present disclosure, a DL transmission may be or include a second transmission, a fourth transmission, and/or a subsequent DL transmission. The DL transmission may be or include a PDCCH, PRDCH and/or PDSCH transmission. The subsequent DL transmission may be a DL transmission after the second transmission or fourth transmission. The subsequent DL transmission may be a DL transmission after an RA procedure is completed.

The first time duration may be the time when a first/second timer is running. The first time duration may be a time window, e.g., to monitor (RA/NW) response. The first timer, the first time duration, and/or the response window (e.g., as described below) may be ra-ResponseWindow and/or a timer for an access procedure (e.g., for ambient IoT). The second timer, the first time duration, and/or the response window (as described below) may be msgB-ResponseWindow and/or a timer for an access procedure (e.g., for ambient IoT). The first time duration may be started after or in response to the first transmission. The first time duration may be used to receive the second transmission for the UE. The first time duration may be used to transmit the second transmission for the NW.

The second time duration may be the time when a third timer is running. The third timer and/or the second time duration may be a contention resolution timer (e.g., ra-ContentionResolutionTimer) and/or a timer for an access procedure (e.g., for ambient IoT). The second time duration may be started after or in response to the third transmission. The second time duration may be used to receive the fourth transmission for the UE. The second time duration may be used to transmit the fourth transmission for the NW.

The above timers may be different timers.

Throughout the present disclosure, the “DL” may be replaced by “Reader to Device (R2D).” A DL transmission may be, be referred to, and/or be supplemented by a transmission from a reader to a device and/or an R2D transmission. A DL data may be, be referred to, and/or be supplemented by a data available on a reader side, a data to be transmitted from a reader to a device, and/or an R2D data. A DL transmission and/or DL data may comprise an indication, configuration, signal/signaling/signalling, and/or message from a reader.

Throughout the present disclosure, the “UL” may be replaced by “Device to Reader (D2R).” a UL transmission may be, be referred to, and/or be supplemented by a transmission from a device to a reader and/or a D2R transmission. A UL data may be, be referred to, and/or be supplemented by a data available on a device side, a data to be transmitted from a device to a reader, and/or a D2R data. A UL transmission and/or UL data may comprise an indication, signal/signaling and/or message from a device. A UL grant may be one or more resource provided from the reader/NW/intermediate node, used by the device/UE and/or used to transmit/perform D2R transmission.

Throughout the present disclosure, the reader may be and/or be replaced by NW/intermediate node, UE, and/or intermediate node. Throughout the present disclosure, the device may be and/or be replaced by UE and/or intermediate node. The device may be referred to as an ambient IoT device. The “UE” may comprise a reader and/or device. The “NW/intermediate node” may comprise a reader.

The UE/device may receive carrier wave(s) from a reader. The UE/device may receive carrier wave(s) from a node other than the reader.

Throughout the present disclosure, the “RA (random access)” may be, be replaced by, and/or be referred to as an access procedure performed by the (ambient IoT) UE/device. The resource(s) and/or configuration(s) for the access procedure may comprise a PDRCH resource(s), occasion(s), frequency, and/or band, e.g., for D2R transmission. The resource(s) and/or configuration(s) for the access procedure may comprise a parameter, random number, group number, and/or assistance information, e.g., for D2R transmission.

Throughout the present disclosure, the “2-step RA” may be, be replaced by, and/or be referred to as a 2-step access procedure performed by the (ambient IoT) UE/device.

Throughout the present disclosure, the “4-step RA” may be, be replaced by, and/or be referred to as a 4-step access procedure performed by the (ambient IoT) UE/device.

The UE may perform a procedure of RA, (initial) access, (ambient IoT) response/report, and/or (R2D/D2R) transmission. The procedure may be a procedure described above. The UE may access the NW/intermediate node, receive signaling/message/configuration, and/or transmit (D2R) data via the procedure. The UE may receive a signaling from the NW/intermediate node (e.g., from a reader). The signaling may be a signaling described above. The signaling may be a query, paging, indication, and/or an R2D message.

In response to (receiving) the signaling, the UE may trigger/perform the procedure and/or following transmission(s). In the procedure, the UE may transmit a first transmission to the NW/intermediate node. The NW/intermediate node may transmit a second transmission to the UE in response to reception/detection of the first transmission. In response to or after transmitting the first transmission, the UE may receive a second transmission from the NW/intermediate node. In response to (receiving) the second transmission, the UE may transmit a third transmission to the NW/intermediate node. The NW/intermediate node may transmit a fourth transmission to the UE in response to reception of the third transmission. The NW/intermediate node may not transmit the fourth transmission to the UE in response to reception of the third transmission. In response to or after transmitting the third transmission, the UE may or may not receive a fourth transmission from the NW/intermediate node. In response to (receiving) the fourth transmission, the UE may transmit a fifth transmission to the NW/intermediate node.

The first transmission in the procedure may be/comprise information of a random number, information of a preamble number, and/or information of an (access) Identity (ID) selected/generated/determined by the UE. The ID may be a random ID.

The second transmission in the procedure may be a response to the first transmission and/or an acknowledgement. The second transmission may indicate, identify, and/or correspond to the first transmission. The second transmission may provide resource(s) for the following D2R transmissions, e.g., the third transmission.

The third transmission in the procedure may be/comprise information of a device/UE ID, report, assistance information, D2R data, and/or information from the UE.

The fourth transmission in the procedure may be a response to the third transmission, an acknowledgement, DL/R2D command, R2D data, and/or a scheduling. The fourth transmission may indicate, identify, and/or correspond to the third transmission. The fourth transmission may provide resource(s) for the following D2R transmissions. The fourth transmission may indicate, notify, and/or allow the fifth transmission.

The fifth transmission in the procedure may be/comprise a feedback (of the fourth transmission), report, assistance information, D2R data, and/or information from the UE.

The first transmission, third transmission and/or fifth transmission may be D2R transmissions and/or PDRCH transmissions. The signaling, second transmission, and/or fourth transmission may be R2D transmissions and/or PRDCH transmissions. The signaling and/or the second transmission may be broadcast, provided and/or transmitted to one or multiple UEs. The second transmission and/or fourth transmission may be provided and/or transmitted to a dedicated UE. The fourth transmission and/or the fifth transmission may be a subsequent transmission during or after the procedure.

Throughout the present disclosure, a Msg1 and/or MSGA may be replaced by a first transmission. Throughout the present disclosure, a Msg2, RAR and/or MSGB may be replaced by a second transmission. Throughout the present disclosure, a MSGA and/or Msg3 may be replaced by a third transmission. Throughout the present disclosure, a MSGB and/or Msg4 may be replaced by a fourth transmission. Throughout the present disclosure, a Message 5 (Msg5) may be replaced by a fifth transmission.

An identity of the UE and/or a UE ID may be or comprise a random number, temporary number, preamble number (e.g., Random Access Preamble ID (RAPID)), and/or ID selected/generated/determined by the UE. An identity of the UE and/or a UE ID may be or comprise a device ID, UE ID, group ID, Contention Resolution Identity, and/or Radio Network Temporary Identifier (RNTI) of the UE. The (access) ID comprised in the first transmission may be different from the device/UE ID comprised in the third transmission.

Throughout the present disclosure, the following may be interchangeable: “initiate a procedure”, “perform a procedure”, “trigger a procedure”, and/or “execute a procedure.”

Throughout the present disclosure, the “CCCH”, “PRACH”, Random Access Channel (“RACH”), “PUSCH” and/or “PUCCH” may be, be comprised by, be replaced by, and/or be referred to as “physical device to reader channel”, a channel for transmission from device to reader, and/or PDRCH. Throughout the present disclosure, the “PDSCH” and/or “PDCCH” may be, be comprised by, be replaced by, and/or be referred to a “(physical) channel”, a “physical reader to device channel”, a channel for transmission from reader to device, and/or PRDCH. A D2R transmission may be transmitted via a PDRCH. An R2D transmission may be transmitted via a PRDCH.

Throughout the present disclosure, the “RA resource(s)/configuration(s)”, “UL resource(s)/configuration(s)”, and/or “resource(s)/configuration(s)” may be, be replaced by, and/or be referred to as resource(s)/configuration(s) for D2R transmission (e.g., as described above). The resource(s) and/or configuration(s) may comprise PDRCH (transmission) resource(s), occasion(s), channel resource(s), frequency resources, and/or (sub-) band(s), e.g., for D2R transmission. The resource(s) and/or configuration(s) may comprise a parameter, random number, group number, and/or assistance information, e.g., for D2R transmission.

The UE may monitor/receive the PRDCH in the procedure of RA, (initial) access and/or (R2D/D2R) transmission.

The UE (e.g., ambient IoT UE) may not transmit an RRC message and/or a (UL) CCCH message in the RA procedure. The UE may transmit a MAC CE to the network, e.g., for initial access. The UE may transmit the MAC CE via a first transmission and/or a third transmission. The UE may include the MAC CE in the first transmission and/or the third transmission. The UE may not include an RRC message and/or a (UL) CCCH message in the first transmission and/or the third transmission. The MAC CE may be and/or include a first information. The MAC CE may be and/or include a UE ID, indication of cause, and/or assistance information. The MAC CE may be a UE ID MAC CE. The MAC CE may be a MAC CE for reporting the first information. The MAC CE may be a MAC CE for requesting resources for reporting the first information. The MAC CE may be a UE Contention Resolution Identity MAC CE. The UE may not trigger an RRC (establishment) procedure. The UE may not establish or set up an RRC connection.

The first information may be, include or indicate one or more of the following:

### UE Type (or Device Type)

The UE may indicate its UE type (or device type) in a UL transmission (explicitly or implicitly).

There may be two or more types of UE (or device). The UE types (device types) may be differentiated by at least energy storage, method to perform a UL transmission, power level, and/or device size. Preferably in certain embodiments, the method to perform a UL transmission may be generated internally by the device/UE or be backscattered on the carrier wave (signal) provided externally.

For example, a first type UE (or device) may be a device A or device B, e.g., as considered in [2] 3GPP TR 38.848 V18.0.0 (2023-09). The first type UE (or device) may have (or be equipped with) a battery or energy storage. The first type UE (or device) may not have (or be equipped with) a battery or energy storage. The first type UE (or device) may not have (or be equipped with) DL/UL amplification. The first type UE (or device) may be a passive or semi-passive device. The first type UE (or device) may generate a UL transmission by backscattering. The first type UE (or device) may perform a backscattering transmission. The first type UE (or device) may not be able to generate a UL transmission (internally) by itself. The first type UE (or device) may not have capability to generate a signal without backscattering.

For example, a second type UE (or device) may be a device C, e.g., as considered in [2] 3GPP TR 38.848 V18.0.0 (2023-09). The second type UE (or device) may have (or be equipped with) a battery or energy storage. The second type UE (or device) may have (or be equipped with) DL/UL amplification. The second type UE (or device) may be an active device. The second type UE (or device) may generate a UL transmission by backscattering. The second type UE (or device) may perform a backscattering transmission. The second type UE (or device) may be able to generate a UL transmission (internally) by itself. The second type UE (or device) may have capability to generate a signal without backscattering.

### Power Level

The UE may indicate its power level in a UL transmission (explicitly or implicitly). The UE may indicate a parameter related to the power level in the transmission.

The power level may comprise any one or more of following embodiments. The power level may be (represented by) a power status of the UE. The UE may utilize the same or different power level embodiment(s) for different RA resources selection (step(s)), e.g., determination of a Bandwidth Part (BWP), determination of an RA resources/configuration group, determination of an RA type, determination of an RA preamble, determination of a PDRCH occasion(s), determination of a RACH occasion(s), and/or determination of a PUSCH occasion(s). There may be one or more thresholds for power level. The power level may be determined by a threshold(s). The threshold(s) for power level may be configured by the network or be derived by the UE. The threshold(s) for power level may be determined based on the following embodiments and/or a (selected) RA resource/configuration.

In one embodiment, the power level may be a received power of a signal/channel transmitted from the network. The power level may be a received power of a carrier-wave (signal) transmitted from the network.

In one embodiment, the power level may be a (downlink) pathloss derived/determined based on at least the received power of the signal/channel transmitted from the network. The power level may be a (downlink) pathloss derived/determined based on at least the received power of the carrier-wave (signal) transmitted from the network.

In one embodiment, the power level may be an expected/derived/determined UE transmit power for a backscattering transmission (e.g., the first transmission and/or the third transmission).

In one embodiment, the power level may be an expected/derived/determined UE transmit power for a UL transmission generated internally by the UE (e.g., the first transmission and/or the third transmission).

In one embodiment, the power level may be a maximum UE transmit power (e.g., for the first transmission and/or the third transmission).

In one embodiment, the power level may be the amount of the UE's battery power/stored power/available power. The UE may estimate/determine/derive how much of the battery power/stored power/available power is utilizable/available for performing the (corresponding) RA procedure.

In one embodiment, the power level may be a predefine/(pre-) configured/indicated power. The indicated power can be indicated by the network or by the higher layer of the UE. Preferably in certain embodiments, the predefine/(pre-) configured/indicated power can be a guaranteed or required power (amount or capacity) for enabling/activating/starting the (corresponding) RA procedure. Preferably in certain embodiments, the predefine/(pre-) configured/indicated power can be an expected/estimated power consumption (amount) for completing the (corresponding) RA procedure.

In one embodiment, the power level may be a power difference between the (downlink) pathloss and the expected/derived/determined/maximum UE transmit power. The (downlink) pathloss may be derived/determined based on at least received power of the signal/channel, e.g., a PRDCH, R2D signal/channel, and/or carrier wave (signal), from the network. The expected/derived/determined UE transmit power may be for backscattering transmission or for UL transmission generated internally by the UE.

In one embodiment, the power level may be a power difference between battery power/stored power/available power and the expected/derived/determined/maximum UE transmit power. The expected/derived/determined UE transmit power may be for backscattering transmission or for UL transmission generated internally by the UE. The UE may estimate/determine/derive how much of the battery power/stored power/available power is utilizable for performing the (corresponding) RA procedure.

In one embodiment, the power level may be a power difference between a predefine/(pre-)configured/indicated power and the expected/derived/determined/maximum UE transmit power. The indicated power can be indicated by the network or by the higher layer of the UE. Preferably in certain embodiments, the predefine/(pre-)configured/indicated power can be a guaranteed or required power (amount or capacity) for enabling/activating/starting the (corresponding) RA procedure. Preferably in certain embodiments, the predefine/(pre-)configured/indicated power can be an expected/estimated power consumption (amount) for completing the (corresponding) RA procedure. The expected/derived/determined UE transmit power may be for a backscattering transmission or for a UL transmission generated internally by the UE.

### (UL) Data Type (or Transmission Type)

The UE may indicate its data type (or transmission type) in a UL transmission (explicitly or implicitly). The data type (or transmission type) may indicate the type of the transmission (or data). The data type (or transmission type) may indicate a use case, traffic scenario, service type, Quality of Service (QoS), logical channel (group), and/or topology. The data type (or transmission type) may be (or include): data, signaling, Device-Originated (DO), Device-Originated-Device-Terminated Triggered (DO-DTT), Device-Terminated (DT), one-shot, data burst, periodic, aperiodic, delay tolerant, and/or emergency.

The (UL) data types may be differentiated by at least a use case, traffic scenario, service type, QoS, logical channel (group), and/or topology. The (UL) data type may be indicated by the network or indicated by the higher layer of the UE. The UE may initiate or trigger the RA procedure for transmitting the UL data.

### (UL) Data Size

The UE may indicate a data size in a UL transmission (explicitly or implicitly).

The (UL) data size may be calculated/derived/determined by the UE. The (UL) data size may be corresponding to the (UL) data type. The UL data size may be a (potential) Transport Block Size (TBS) of a MSGA payload and/or a Msg3. The UL data size may be a (potential) TBS of the first transmission in the RA procedure. The (UL) data size may be a TBS of ambient IoT information (or data). The UE may initiate or trigger the RA procedure for transmitting the UL data.

### UE ID

The UE may indicate its UE ID in a UL transmission (explicitly or implicitly). The UE ID may be used to identify a UE (e.g., in an area). The UE ID may be stored by the UE. The UE ID may be a temporary ID.

A UE may be assigned a UE ID. The UE may be predefined or (pre-) configured (e.g., by the NW) the UE ID. The UE may be configured or indicated (e.g., by the NW) the UE ID. The UE may calculate, select, derive, or determine the UE ID by itself. The UE ID may be a random value. The UE ID may be ue-Identity.

### UE Group ID

The UE may indicate its UE group ID in a UL transmission (explicitly or implicitly).

There may be multiple UE groups. A UE may be assigned or associated with a UE group. The UE may be predefined or (pre-)configured (e.g., by the UE) with the UE group. The UE may be configured or indicated (e.g., by the NW) with the UE group. The UE may receive a group ID and/or a value to derive/determine the group ID via paging, SIB, and/or PDCCH/PRDCH.

The multiple UEs may be assigned to different UE groups based on the UE types. The UEs with the same UE type may be in a same UE group. The UEs with the same UE type may be in different UE groups. A UE group may comprise UEs with the same or different UE type.

The multiple UEs may be assigned to or associated with different UE groups based on the UE ID. For example, a UE may be assigned to or associated with a UE group, wherein the UE group ID of the UE group may be decided/derived/determined based on at least the UE ID of the UE and a value. Preferably in certain embodiments, the UE group ID of the UE may be decided/derived/determined by the UE ID mod the value. The value may be the number of UE groups. The value may be provided/configured by the NW or be pre-defined or be (pre-)configured. The UE group ID of the UE may be decided by a formula using the UE ID.

The multiple UEs may be assigned to different UE groups based on location. Preferably in certain embodiments, the UEs in a same location and/or a same position range may be distributed to the same UE groups. A UE may determine/derive its location or range based on a received carrier wave (signal), R2D signal/channel, and/or PRDCH. More specifically, the UE may determine/derive its location or range from a network/intermediate node based on a received power of a carrier wave (signal), R2D signal/channel, and/or PRDCH transmitted from the network/intermediate node. The UEs in the same location and/or the same range may mean the UEs with the same received power range of the carrier wave (signal), R2D signal/channel, and/or PRDCH. Preferably and/or alternatively, the UEs in a same location and/or same position range may be distributed to different UE groups. The UEs among the range in which could receive the same power source, carrier wave, and/or NW signal (e.g., R2D signal/channel, PRDCH) may be (randomly) distributed to different UE groups.

### Cause

The cause of the (first or second) signaling (or the transmission) may be provided (or indicated). The cause may indicate at least one or more of the following: a DO-DTT (transmission), a DT (transmission), a DO transmission, a first type data (transmission), a second type data (transmission), a (service/measurement/status) report (transmission), a signaling (transmission), a first type UE (transmission), a second type UE (transmission), an ambient IoT (transmission), and/or a non-ambient IoT (transmission).

The cause of the (first or second) signaling (or the transmission) may indicate the transmission type (e.g., DO-DTT, DT, DO). The cause of the (first or second) signaling (or the transmission) may indicate the data type (as described above). The cause of the (first or second) signaling (or the transmission) may indicate the UE type (as described above). The cause of the (first or second) signaling (or the transmission) may indicate whether the UE is an ambient IoT UE or is capable of ambient IoT.

### Position or Location Information

The position (or location) of the UE may be provided (or indicated). The information may be (or include, or indicate) coordinates of the UE. The information may be (or include, or indicate) an area where the UE is located. The information may be (or include, or indicate) an area ID. The area may be (or include) a cell, a tracking area, or a range of area scope.

### Information Related to (Data) Traffic

Information related to (data) traffic of the UE may be provided (or indicated). The information may be (or include, or indicate) at least one or more of the following: a traffic pattern, time information related to data (or packet) arrival, how long the (next) data is expected to arrive, latency requirement of data (or packet), priority of the data (or packet), importance of the data (or packet), the expected time of (next) data arrival, (expected) data inter-arrival time, a period of data arrival.

### Information Related to UE Wake Up

Information related to UE wake up may be provided (or indicated). The information may be (or include, or indicate) at least one or more of the following: (expected or preferred) wake up time of the UE, time information related to UE wake up, information related to UE active time, the time that the UE will wake up (or wish to wake up), how long until the next time the UE will wake up. The UE wake up may represent that the UE monitors a DL/R2D signaling (e.g., carrier wave, R2D signal/channel) or PDCCH/PRDCH.

### (Required) TB Size

Information related to (required) Transport Block (TB) size may be provided (or indicated). The UE may not perform data segmentation (e.g., RLC segmentation). The UE may need to be allocated (or scheduled) with a UL grant with a TB size which can accommodate an upper layer Service Data Unit (SDU). The (required) TB size may be a minimum size that the UE can use to perform a (data) transmission. The TB size may be a preferred value that the UE can use to perform a (data) transmission.

### (Required) Repetition Number

Information related to a (required) repetition number (used) for an uplink transmission (e.g., Msg1, preamble, Msg3, MSGA, and/or etc.) may be provided (or indicated).

### Acknowledgement

Information for acknowledgement may be provided (or indicated). The acknowledgement may be used to acknowledge the reception of the (first) signaling. The acknowledgement may be used to acknowledge a previous reception (or transmission).

According to the study item of ambient IoT ([1] RP-234058), an ambient IoT UE has limited energy storage (may possibly even be with no energy storage). Comparing a New Radio (NR) UE with power consumption of mW (e.g., maximum UE transmit power 23 dBm corresponds to 199.5 mW), output power of an ambient IoT UE may be typically from 1 μW to a few hundreds of μW. Considering the limited energy of an ambient IoT UE, it may not be a good choice for an ambient IoT UE to monitor PDCCH/PRDCH for a long time. Except output power consumption, power consumption due to PDCCH/PRDCH monitoring in an RA procedure (e.g., in the first/second time duration) may need to be enhanced.

In legacy NR, the UE could receive a paging to trigger a random access procedure. The UE transmits a Msg1 at a selected PRACH occasion configured by a system information, and starts to monitor a corresponding Msg2 at the earliest Control Resource Set (CORESET) for PDCCH after the Msg1 transmission. The CORESET is configured by the network in the RRC layer. In ambient IoT, assuming that there would not be the timing defined by the CORESET. After an ambient IoT UE receives paging signaling to trigger a random access, the UE needs to decide when to monitor the corresponding response for its Msg1 during the random access. Further considerations on the possibility that there would be multiple ambient IoT UEs performing random access using different time-domain resources in a same round (i.e., triggered by the same network signaling).

To solve the issue, the UE (e.g., ambient IoT UE) could monitor the PDCCH/PRDCH for (receiving) a DL/R2D transmission in a one-shot or a (limited/specific) time duration (e.g., shorter than the time duration for legacy UE) (e.g., during an RA procedure). The ambient IoT UE could monitor the PDCCH/PRDCH for (receiving) the DL/R2D transmission in the (limited/specific) time duration. A legacy UE or non-ambient IoT UE may monitor PDCCH/PRDCH for (receiving) MSG2, MSGB, MSG4, and/or a NW response/signal in another time duration. Generally, the another time duration is (assumed/expected to be) longer than the (limited/specific) time duration. The UE could start to monitor the PDCCH/PRDCH for (receiving) a DL/R2D transmission at a specific timing. The network could transmit the DL/R2D transmission in the (limited/specific) time duration. The DL/R2D transmission may be a second transmission and/or a fourth transmission. The time duration may be or include the first time duration and/or the second time duration. The (limited/specific) time duration may start at the specific timing. The specific timing may be the start of the time duration.

In one or more examples, the (limited/specific) time duration may start at a specific timing after a (UL/D2R) transmission. The (UL/D2R) transmission may be or include a first transmission or a third transmission. The (UL/D2R) transmission may be a first transmitted (UL/D2R) transmission in repetitions and/or bundle. The (UL/D2R) transmission may be a last transmitted (UL/D2R) transmission in repetitions and/or bundle. If the UE performs repetition/bundle of the (UL/D2R) transmissions, the specific timing may be derived/determined based on the first/initial one or the last one among the repetition/bundle of the (UL/D2R) transmissions. The (UL/D2R) transmission may be a new/initial/first transmission in an RA procedure. The (UL/D2R) transmission may be a retransmission in the RA procedure. The time duration may start (at a PDCCH/PRDCH occasion and/or in a symbol that) after the UL transmission plus a time offset. The time duration may start at a PDCCH/PRDCH occasion and/or in a symbol of the end of the (UL/D2R) transmission plus the time offset. The time duration may start at the first PDCCH/PRDCH occasion and/or in a symbol from the end of the (UL/D2R) transmission plus the time offset. The time duration may start at a PDCCH/PRDCH occasion and/or in a symbol that is after the end of the UL transmission plus the time offset. The time duration may not start (at a PDCCH/PRDCH occasion and/or in a symbol) upon the (corresponding) (UL/D2R) transmission.

The UE may (start to) monitor the PDCCH/PRDCH (at a PDCCH/PRDCH occasion and/or in a symbol that is) after the (UL/D2R) transmission plus a time offset. The UE may (start to) monitor the PDCCH/PRDCH at a PDCCH/PRDCH occasion and/or in a symbol of the end of the (UL/D2R) transmission plus the time offset. The UE may (start to) monitor the PDCCH/PRDCH at the first PDCCH/PRDCH occasion and/or in a symbol from the end of the (UL/D2R) transmission plus the time offset. The UE may (start to) monitor the PDCCH/PRDCH at a PDCCH/PRDCH occasion and/or in a symbol that is after the end of the (UL/D2R) transmission plus the time offset.

The NW may (start to) transmit the PDCCH/PRDCH (at a PDCCH/PRDCH occasion and/or in a symbol that is) after the UL/D2R transmission plus a time offset. The NW may (start to) transmit the PDCCH/PRDCH at a PDCCH/PRDCH occasion and/or in a symbol of the end of the (UL/D2R) transmission plus the time offset. The NW may (start to) transmit the PDCCH/PRDCH at the first PDCCH/PRDCH occasion and/or in a symbol from the end of the (UL/D2R) transmission plus the time offset. The NW may (start to) transmit the PDCCH/PRDCH at a PDCCH/PRDCH occasion and/or in a symbol that is after the end of the (UL/D2R) transmission plus the time offset.

In one or more examples, the time duration may start at a specific timing after receiving an NW signaling. The time duration may start at the arrival time of a (next) NW signaling. The NW signaling may be or include a PRDCH, R2D signal/channel, paging, carrier wave (signal), and/or interrogation signal. The NW signaling may be an NW signaling received before the UE triggers the RA procedure. The NW signaling may be an NW signaling indicating the UE to trigger the RA procedure. The NW signaling may be an NW signaling received after the UE triggers the RA procedure. The NW signaling may be an NW signaling providing energy for the UE, e.g., to trigger the RA procedure, perform UL/D2R transmission(s), monitor the PDCCH/PRDCH, and/or receive DL/R2D transmission(s). The NW signaling may be or include a second transmission. The time duration may start (at a PDCCH/PRDCH occasion and/or in a symbol that) after receiving the NW signaling plus a time offset. The time duration may start at a PDCCH/PRDCH occasion and/or in a symbol of the end of the NW signaling plus the time offset. The time duration may start at the first PDCCH/PRDCH occasion and/or in a symbol from the end of the NW signaling plus the time offset. The time duration may start at a PDCCH/PRDCH occasion and/or in a symbol that is after the end of the NW signaling plus the time offset.

The UE may (start to) monitor the PDCCH/PRDCH (at a PDCCH/PRDCH occasion and/or in a symbol that) after receiving the NW signaling plus a time offset. The UE may (start to) monitor the PDCCH/PRDCH at a PDCCH/PRDCH occasion and/or in a symbol of the end of the NW signaling plus the time offset. The UE may (start to) monitor the PDCCH/PRDCH start at the first PDCCH/PRDCH occasion and/or in a symbol from the end of the NW signaling plus the time offset. The UE may (start to) monitor the PDCCH/PRDCH at a PDCCH/PRDCH occasion and/or in a symbol that is after the end of the NW signaling plus the time offset. The UE may not (start to) monitor the PDCCH/PRDCH upon an (corresponding) UL/D2R transmission.

The NW may (start to) transmit the PDCCH/PRDCH (at a PDCCH/PRDCH occasion and/or in a symbol that) after transmitting the NW signaling plus a time offset. The NW may (start to) transmit the PDCCH/PRDCH at a PDCCH/PRDCH occasion and/or in a symbol of the end of the NW signaling plus the time offset. The NW may (start to) transmit the PDCCH/PRDCH start at the first PDCCH/PRDCH occasion and/or in a symbol from the end of the NW signaling plus the time offset. The NW may (start to) transmit the PDCCH/PRDCH at a PDCCH/PRDCH occasion and/or in a symbol that is after the end of the NW signaling plus the time offset. The NW may not (start to) transmit the PDCCH/PRDCH upon reception of the UL/D2R transmission.

The UE may receive a first signaling to trigger a random access procedure and transmit a first transmission (e.g., Msg1) in the random access procedure. The UE may determine a start time (e.g., third timing) to monitor a second transmission (e.g., Msg2) based on: a first timing of receiving the first signaling and time delay, or a second timing of transmitting the first transmission and a time delay. The time delay may be indicated by the network and/or is derived or calculated by the UE. The first signaling may be a paging for an ambient IoT. The first signaling is for more than one UE. The third timing for starting of monitoring the second transmission may be common for the more than one UE. An example is shown in FIG. 9. More details are described as follows.

In one or more examples, the UE receives a first signaling of triggering a random access (procedure). The first signaling is a paging for an ambient IoT. The first signaling is for more than one UE. The first signaling indicates/triggers the more than one UE to trigger/perform the random access (procedure(s)). The first signaling indicates at least a resource of at least a first transmission. The first signaling indicates the resource(s) for the first transmission(s) for the more than one UE. The first signaling indicates one or more UE IDs, group IDs, and/or no ID for the more than one UE. In response to (receiving) the first signaling, the UE triggers the random access (procedure). The UE transmits the first transmission during the random access (procedure). The first transmission comprises at least a random ID. The UE determines a third timing based on at least a first timing and a first time delay. The first timing is the end of the first signaling. Preferably in certain embodiments, the first timing is or is after the last occasion of the first signaling. The first time delay is at least one of: a pre-defined value, indicated by the network (e.g., via the first signaling), derived or calculated by the UE, and/or derived or calculated by the UE based on at least an indication/configuration/resource provided by the first signaling and/or the pre-defined value. In response to transmitting the first transmission, the UE monitors a second transmission (e.g., on a channel) starting from the third timing. The third timing is a start time for monitoring the second transmission (e.g., on the channel). The third timing is common for the more than one UE. The third timing is determined based on at least the first timing plus the first time delay. Preferably in certain embodiments, the third timing is after the first timing plus the first time delay. The UE receives the second transmission while/after monitoring the second transmission (e.g., on the channel). The second transmission corresponds to the first transmission. The second transmission comprises at least a network response to at least the first transmission. The second transmission comprises at least the random ID. The first signaling and/or the second transmission is received from a reader. The first transmission is transmitted to the reader. The reader is the network or another UE.

In one or more examples, the UE receives a first signaling of triggering a random access (procedure). The first signaling is a paging for ambient IoT. The first signaling is for more than one UE. The first signaling indicates/triggers the more than one UE to trigger/perform the random access (procedure(s)). The first signaling indicates at least a resource of at least a first transmission. The first signaling indicates resource(s) for first transmission(s) for the more than one UE. The first signaling indicates one or more UE IDs, group IDs, and/or no ID for the more than one UE. In response to (receiving) the first signaling, the UE triggers the random access (procedure). The UE transmits the first transmission during the random access (procedure). The first transmission comprises at least a random ID. The UE determines a third timing based on at least a second timing and a second time delay. The second timing is the end of the first transmission. Preferably in certain embodiments, the second timing is or is after the last occasion of the first transmission. The second time delay is derived or calculated by the UE. The second time delay is derived or calculated based on at least one of: an indication/configuration/resource provided by the first signaling and/or a pre-defined value, and/or a time association between the first transmission and the second transmission. In response to transmitting the first transmission, the UE monitors a second transmission (e.g., on a channel) starting from the third timing. The third timing is a start time for monitoring the second transmission (e.g., on the channel). The third timing is common for the more than one UE. The third timing is determined based on at least the second timing plus the second time delay. Preferably in certain embodiments, the third timing is after the second timing plus the second time delay. The UE receives the second transmission while/after monitoring the second transmission (e.g., on the channel). The second transmission corresponds to at least the first transmission. The second transmission comprises at least a network response to at least the first transmission. The second transmission comprises at least the random ID. The first signaling and/or the second transmission is received from a reader. The first transmission is transmitted to the reader. The reader is the network or another UE.

In one or more examples, the reader transmits a first signaling of triggering one or more random access (procedures), e.g., to more than one UE. The first signaling is a paging for ambient IoT. The first signaling indicates/triggers the more than one UE to trigger/perform the random access (procedure(s)). The first signaling indicates at least a resource of at least a first transmission. The first signaling indicates resource(s) for first transmission(s) for the more than one UE. The first signaling indicates one or more UE IDs, group IDs, and/or no ID for the more than one UE. In response to (transmitting) the first signaling, the reader receives at least one first transmission from at least one UE of the more than one UE. The first transmission comprises at least a random ID of the at least one UE. In response to (receiving) the at least one first transmission, the reader transmits at least one second transmission for the at least one UE after a third timing. The third timing is common for the more than one UE. The reader determines the third timing based on at least a first timing and a first time delay. The first timing is the end of the first signaling. Preferably in certain embodiments, the first timing is or is after the last occasion of the first signaling. The first time delay is at least one of: a pre-defined value, indicated by the reader (e.g., via the first signaling), derived or calculated by the UE, and/or derived or calculated by the UE based on at least an indication/configuration/resource provided by the first signaling and/or the pre-defined value. The third timing is a start time for transmitting the second transmission. The third timing is common for the more than one UE. The third timing is determined based on at least the first timing plus the first time delay. Preferably in certain embodiments, the third timing is after the first timing plus the first time delay. The second transmission corresponds to at least the first transmission. The second transmission comprises at least a network response to at least the first transmission. The second transmission comprises at least the random ID of the at least one UE. The first signaling and the second transmission is transmitted to the at least one UE and/or the more than one UE. The first transmission is received from the at least one UE and/or the more than one UE. The reader is the network or another UE.

A part of or whole of the above examples could be combined.

Throughout the present disclosure, the time offset and/or time difference may be a Round Trip Time (RTT) and/or time delay. The specific timing and/or the time offset may be indicated, (pre-) defined, and/or (pre-)configured by the network (e.g., via network signaling as described above). The specific timing and/or the time offset may be specified in a specification, e.g., TS 38.213. The specific timing and/or the time offset may be associated with an indication and/or a configuration provided by the network. The specific timing and/or the time offset may be calculated and/or derived by the UE. The specific timing and/or the time offset may be common for multiple or a group of ambient IoT UEs (which receive the same NW signal). The specific timing and/or the time offset may be dedicated/specific for each ambient IoT UE.

The UE may monitor the PDCCH/PRDCH/channel during the (limited/specific) time duration, e.g., in response that the UE performs the corresponding UL/D2R transmission(s) (e.g., the first transmission). The UE may receive a DL/R2D transmission on the PDCCH/PRDCH/channel or receive a DL/R2D transmission scheduled by the PDCCH/PRDCH/channel during the time duration. The UE may not (start to) monitor the PDCCH/PRDCH/channel upon the (corresponding) UL/D2R transmission. The UE may not monitor the PDCCH/PRDCH/channel before the specific timing. The UE may not receive a DL/R2D transmission outside the time duration. The UE may not receive a DL/R2D transmission before the specific timing.

Alternately and/or additionally, the UE may start the first timer, second timer, and/or third timer at the specific timing. The value of the first timer, second timer, and/or third timer for ambient IoT UE may be shorter than the value for a legacy UE. The value of the first timer, second timer, and/or third timer for an ambient IoT UE may be fixed. The value of the first timer, second timer, and/or third timer for an ambient IoT UE may be the shortest configurable value of the timer. The UE may monitor the PDCCH/PRDCH when the first timer, second timer, and/or third timer is running. The UE may not monitor the PDCCH/PRDCH (e.g., for the second transmission or the fourth transmission) when the first timer, second timer, and/or third timer is not running. The NW may not transmit a DL/R2D transmission or response when the first timer, second timer, and/or third timer is not running.

In one or more examples, the UE may transmit a Msg1 to the network. After or in response to transmitting the Msg1, the UE may start a response window (e.g., ra-ResponseWindow) at a specific timing after (the end of) the Msg1 transmission. The specific timing may be the first PDCCH/PRDCH occasion from the end of the Msg1 transmission plus a time offset. The specific timing may be the arrival time of a next NW signaling. The specific timing may be configured and/or indicated by the network (e.g., in NW signaling). The UE may monitor the PDCCH/PRDCH when the response window is running (or during the response window). The UE may receive a RAR from the network when the response window is running (or during the response window). In response to (receiving) the RAR, the UE may transmit a Msg3 to the network. After or in response to transmitting the Msg3, the UE may start a contention resolution timer (e.g., ra-ContentionResolutionTimer) at a specific timing after (the end of) the Msg3 transmission. The specific timing may be the first symbol after the end of the Msg3 transmission plus a time offset. The specific timing may be the arrival time of a next NW signaling. The specific timing may be configured and/or indicated by the network (e.g., in NW signaling). The UE may monitor the PDCCH/PRDCH when the contention resolution timer is running. The UE may receive a Msg4 from the network when the contention resolution timer is running.

In one or more examples, the UE may transmit a MSGA to the network. After or in response to transmitting the MSGA, the UE may start a response window (e.g., msgB-Response Window) at a specific timing after (the end of) the MSGA transmission. The specific timing may be a PDCCH/PRDCH occasion of the end of the MSGA transmission plus a time offset. The specific timing may be the arrival time of a next NW signaling. The specific timing may be configured and/or indicated by the network (e.g., in NW signaling). The UE may monitor the PDCCH/PRDCH when the response window is running (or during the response window). The UE may receive a MSGB from the network when the response window is running (or during the response window).

Alternately and/or additionally, the UE may start the first timer, second timer, and/or third timer in response to the UL/D2R transmission. The UE may start a fourth timer in response to the UL/D2R transmission and/or the start of the first timer, second timer, and/or third timer. The fourth timer may represent as the time offset. The fourth timer may be a delay timer, prohibit timer, and/or inactive timer. The fourth timer may end at the specific timing. The fourth timer may expire at the specific timing. The UE may not monitor the PDCCH/PRDCH when/if (at least) the fourth timer is running. The UE may monitor the PDCCH/PRDCH when the first timer, second timer, and/or third timer is running and when/if (at least) the fourth timer is not running. The NW may not transmit a DL/R2D transmission or response when the fourth timer is running.

In one or more examples, the UE may transmit a Msg1 to the network. After or in response to transmitting the Msg1, the UE may start a response window (e.g., ra-ResponseWindow) at the first PDCCH/PRDCH occasion from the end of the Msg1 transmission. The UE may start a fourth timer with a first value (e.g., first time length value or first value of Transmission Time Intervals (TTIs)/occasions/symbols/milliseconds) at the first PDCCH/PRDCH occasion from the end of the Msg1 transmission. The UE may start the fourth timer at a timing configured and/or indicated by the network (e.g., in NW signaling). The UE may monitor the PDCCH/PRDCH when the response window is running (or during the response window) and the fourth timer is not running. The UE may monitor the PDCCH/PRDCH during the response window when the fourth timer is not running. The UE may receive a RAR from the network after the fourth timer expires. In response to (receiving) the RAR, the UE may transmit a Msg3 to the network. After or in response to transmitting the Msg3, the UE may start a contention resolution timer (e.g., ra-ContentionResolutionTimer) at a first symbol after the end of the Msg3 transmission. The UE may start the fourth timer with a second value (e.g., second time length value or second value of TTIs/occasions/symbols/milliseconds) at the first PDCCH/PRDCH occasion from the end of the Msg3 transmission. The UE may start the fourth timer at a timing configured and/or indicated by the network (e.g., in NW signaling). The UE may monitor the PDCCH/PRDCH when the contention resolution timer is running and the fourth timer is not running. The UE may receive a Msg4 from the network after the fourth timer expires. The first value and the second value may be the same. The first value and the second value may be different. The first value and the second value may be configured, indicated, and/or provided by the network. The first value and the second value may be derived by the UE.

In one or more examples, the UE may transmit a Msg1 to the network. After or in response to transmitting the Msg1, the UE may start a response window (e.g., ra-ResponseWindow) at the first PDCCH/PRDCH occasion from the end of the Msg1 transmission. The UE may start a fourth timer with a first value (e.g., first time length value or first value of TTIs/occasions/symbols/milliseconds) at the first PDCCH/PRDCH occasion from the end of the Msg1 transmission. The UE may start the fourth timer at a timing configured and/or indicated by the network (e.g., in NW signaling). The UE may monitor the PDCCH/PRDCH when the response window is running (or during the response window) and the fourth timer is not running. The UE may monitor the PDCCH/PRDCH during the response window when the fourth timer is not running. The UE may receive a RAR from the network after the fourth timer expires. In response to (receiving) the RAR, the UE may transmit a Msg3 to the network. After or in response to transmitting the Msg3, the UE may start a contention resolution timer (e.g., ra-ContentionResolutionTimer) at a first symbol after the end of the Msg3 transmission. The UE may start another fourth timer with a second value (e.g., second time length value or second value of TTIs/occasions/symbols/milliseconds) at the first PDCCH/PRDCH occasion from the end of the Msg3 transmission. The UE may start the other/another fourth timer at a timing configured and/or indicated by the network (e.g., in NW signaling). The UE may monitor the PDCCH/PRDCH when the contention resolution timer is running (or during the response window) and the another fourth timer is not running. The UE may receive a Msg4 from the network after the another fourth timer expires. The first value and the second value may be the same. The first value and the second value may be different. The first value and the second value may be configured, indicated, and/or provided by the network. The first value and the second value may be derived by the UE. The fourth timer and the other/another fourth timer may be the same timer. The fourth timer and the other/another fourth timer may be different timers.

In one or more examples, the UE may transmit a MSGA to the network. After or in response to transmitting the MSGA, the UE may start a response window (e.g., msgB-ResponseWindow) at the PDCCH/PRDCH occasion after the MSGA transmission. The UE may start a fourth timer at the PDCCH/PRDCH occasion after the MSGA transmission. The UE may start the fourth timer at a timing configured and/or indicated by the network (e.g., in NW signaling). The UE may monitor the PDCCH/PRDCH when the response window is running (or during the response window) and the fourth timer is not running. The UE may monitor the PDCCH/PRDCH during the response window when the fourth timer is not running. The UE may receive a MSGB from the network after the fourth timer expires.

In one or more examples, the (limited/specific) time duration is one TTI/occasion. Preferably in certain embodiments, the (limited/specific) time duration may be/mean the specific timing. Preferably in certain embodiments, the specific timing may be one TTI/occasion.

Preferably in certain embodiments, when the UE performs the UL/D2R transmission, the UE may monitor PDCCH/PRDCH for (receiving) a corresponding DL/R2D transmission at the specific timing. Preferably in certain embodiments, when the NW receives the UL/D2R transmission, the NW may transmit PDCCH/PRDCH for (transmitting) a corresponding DL/R2D transmission at the specific timing.

Preferably in certain embodiments, the UE may derive/determine the specific timing based on transmission timing of the UL/D2R transmission (e.g., the first transmission). Preferably in certain embodiments, the UE may derive/determine the specific timing based on a timing association/correspondence (e.g., a time difference) with the transmission timing of the UL/D2R transmission (e.g., the first transmission). Preferably in certain embodiments, the timing association/correspondence may be configured, indicated and/or provided by the network (e.g., in the NW signaling, via an information in the NW signaling). Preferably and/or alternatively, the timing association/correspondence may be predefined/fixed/specified/pre-configured.

Preferably in certain embodiments, if the UE performs repetition/bundle of the UL transmissions, the specific timing may be derived/determined based on the first/initial one or the last one among the repetition/bundle of the UL transmissions.

Preferably in certain embodiments, the specific timing may be later than or equal to the transmission timing of the UL transmission plus a time offset (e.g., the time offset described above). Preferably in certain embodiments, for different kinds of the UL transmissions, the time offset may be the same or different. Preferably in certain embodiments, for different kinds of the UL transmissions, the timing association/correspondence with transmission timing of UL transmission and corresponding specific timing may be the same or different. Preferably in certain embodiments, for different kinds of the UL transmissions, the resource association/correspondence with transmission resource of UL transmission and corresponding one or more specific resources may be the same or different.

In one or more examples, when the UE performs the UL/D2R transmission, the UE may monitor PDCCH/PRDCH on one or more specific resources (e.g., PDCCH/PRDCH resources(s), candidate PDCCH/PRDCH resource(s)) at the specific timing or the (limited/specific) time duration. Preferably in certain embodiments, when the NW receives the UL/D2R transmission, the NW may transmit PDCCH/PRDCH for (transmitting) a corresponding DL transmission on one of the one or more specific resources at the specific timing or the (limited/specific) time duration.

Preferably in certain embodiments, the UE may derive/determine the one or more specific resources based on resource association/correspondence (e.g., resource association/correspondence in frequency, time, and/or code domain) with transmission resource of the UL transmission. Preferably in certain embodiments, the resource association/correspondence may be configured, indicated, and/or provided by the network (e.g., in the NW signaling). Preferably and/or alternatively, the resource association/correspondence may be predefined/fixed/specified/pre-configured.

Preferably in certain embodiments, the one or more specific resources may be (or include) one specific resource. In this case, the resource association/correspondence may be one-to-one between PDCCH/PRDCH resource and transmission resource of the UL/D2R transmission (e.g., PRACH resources, PUSCH resources, PDRCH resources).

Preferably in certain embodiments, the transmission resource of the UL transmission may be/mean/comprise the lowest frequency unit (e.g., lowest Physical Resource Block (PRB), lowest Resource Element (RE), or lowest sub-carrier) of the transmission resource of the UL transmission.

The above example(s), method(s), concept(s), and/or embodiment(s) for PDCCH/PRDCH/channel monitoring could be combined. Preferably in certain embodiments, for different kinds of the UL/D2R transmissions, different example(s), method(s), concept(s), and/or embodiment(s) for PDCCH/PRDCH monitoring may be applied accordingly. The different kinds of the UL/D2R transmissions may be differentiated based on the first information. The different kinds of the UL/D2R transmissions may be associated with different UE types, power levels, data types, data size, UE ID, UE group ID, cause, location, and/or repetition number.

After the UE triggers the RA procedure and/or performs the UL transmission(s), since there may be collision when multiple UEs performs RA procedures, the UE needs to determine the contention resolution of the RA procedure, e.g., whether the UL transmission is successfully received by the network, whether the RA procedure could be considered as successfully completed. Based on the current NR MAC specification TS 38.321, the UE determines the contention resolution under two cases: one is the case that Cell Radio Network Temporary Identifier (C-RNTI) MAC CE is included in Msg3 or MSGA, and the other is the case that CCCH SDU is included Msg3 or MSGA. However, for an ambient IoT UE, the two cases may not be applicable (since there may be no C-RNTI MAC CE or CCCH SDU in Msg3 or MSGA), or the determination of contention resolution for the at least one of the cases may not be appropriate for an ambient IoT UE.

To solve the issue, the UE could receive a PDCCH/PRDCH (order/transmission) as the NW response for the UL/D2R transmission(s) in the RA procedure. In response to transmitting a first transmission and/or a third transmission, the UE may receive a PDCCH/PRDCH transmission without PDSCH transmission. The UE may not receive a PDSCH (transmission), payload, MAC PDU, and/or TB. The UE may not receive a MSGB and/or Msg4 (e.g., MSGB and/or Msg4 via PDSCH). The UE may receive the PDCCH/PRDCH transmission as a MSGB and/or Msg4. The PDCCH/PRDCH transmission may be addressed to an Random Access Radio Network Temporary Identifier (RA-RNTI), MSGB-RNTI, and/or Temporary Cell Radio Network Temporary Identifier (TC-RNTI). The PDCCH/PRDCH transmission may be scrambling with the UE ID. The PDCCH/PRDCH transmission may be scrambling with part of the UE ID, e.g., the first x bits of the UE ID (e.g., x Least Significant Bit (LSB) bits or x Most Significant Bit (MSB) bits). The PDCCH/PRDCH transmission may indicate the UE ID. The PDCCH/PRDCH transmission may indicate part of the UE ID, e.g., the first x bits of the UE ID (e.g., x LSB bits or x MSB bits). The PDCCH/PRDCH transmission may comprise a field indication of the UE ID. The PDCCH/PRDCH transmission may comprise a field indication of part of the UE ID, e.g., the first x bits of the UE ID (e.g., x LSB bits or x MSB bits). The UE may consider the PDCCH/PRDCH transmission including or scrambling (part of) the UE ID as a MSGB and/or Msg4.

Preferably in certain embodiments, the PDCCH/PRDCH transmission being scrambled with the UE ID may mean/comprise that the PDCCH/PRDCH includes downlink control information and Cyclic Redundancy Check (CRC) bits of the downlink control information is scrambled with (part of) the UE ID.

Preferably in certain embodiments, the PDCCH/PRDCH transmission comprising the field indication of (part of) the UE ID may mean/comprise that the PDCCH/PRDCH includes downlink control information and the downlink control information comprises the field indication of (part of) the UE ID.

For example, the UE may include its UE ID (e.g., via an RRC message, via a MAC CE) in a Msg3 and/or MSGA. The UE may transmit the Msg3/MSGA with the UE ID. In response to transmitting the Msg3/MSGA, the UE may monitor the PDCCH/PRDCH (e.g., based on above examples) and receive a PDCCH/PRDCH transmission. The UE may consider contention resolution successful, consider RAR reception successful, and/or consider the RA procedure successfully completed, if (at least) or based on one or more combinations of the following conditions being fulfilled:
a notification of a reception of a PDCCH/PRDCH transmission (of a Special Cell (SpCell)) is received from lower layers;
the PDCCH/PRDCH transmission is addressed to an RA-RNTI of the UE;
the PDCCH/PRDCH transmission is addressed to a TC-RNTI of the UE;
the PDCCH/PRDCH transmission is addressed to a MSGB-RNTI of the UE;
the PDCCH/PRDCH transmission is scrambling with (part of) the UE ID;
the PDCCH/PRDCH transmission indicates (part of) the UE ID;
the PDCCH/PRDCH transmission comprises (part of) the UE ID;
an indication in the PDCCH/PRDCH transmission matches (part of) the UE ID;
the PDCCH/PRDCH transmission indicates a RAPID, e.g., wherein the RAPID is transmitted via the first transmission;
the UE is an ambient IoT UE;
the RA procedure is initiated for ambient IoT; and/or
the RA procedure is triggered by NW signaling (e.g., PRDCH signal, R2D signal/channel, carrier wave, interrogation signal).

The UE may receive configurations related to ambient IoT. The UE may receive RA configurations and/or RA resources. The RA resources may comprise BWP, RA resources/configuration group, RA preamble (group), PDRCH occasion(s), RACH occasion(s), and/or PUSCH occasion(s). The UE may receive the above configurations and/or resources via a network signaling (as described above).

The above example(s), method(s), concept(s) and/or embodiment(s) for UL/D2R transmission, DL/R2D reception/transmission, PDCCH/PRDCH/channel monitoring, and/or contention resolution could be combined.

Throughout the present disclosure, the following may be interchangeable: RACH occasion(s), PRACH occasion(s).

Throughout the present disclosure, the “RA procedure” may be replaced by “(initial) access procedure”. The “(initial) access procedure” may be contention-based or contention-free.

Throughout the present disclosure, the “RA procedure” may be changed/represented/replaced as a UE (or ambient IoT) data transmitting procedure, UE (or ambient IoT) response procedure, or UE (or ambient IoT) reporting procedure.

Throughout the present disclosure, the “RA” may be replaced by “access”.

Throughout the present disclosure, the “MSGA” or “MSGA payload” may be replaced by “PDRCH data/transmission/signaling”, “(uplink/D2R) data”, and/or “(uplink/D2R) signaling”.

Throughout the present disclosure, the “Msg1” may be replaced by “RA preamble”.

Throughout the present disclosure, the “PRACH” may be replaced by “PDRCH”, “channel for random access”, or “PRACH for ambient IoT”.

Throughout the present disclosure, the “PUSCH” may be replaced by “PDRCH”, “uplink shared channel”, or “PUSCH for ambient IoT”, or “physical channel for D2R (data/control) transmission”.

Throughout the present disclosure, the “PDCCH” may be replaced by “PRDCH”, “downlink control channel”, “downlink control information”, or “PDCCH for ambient IoT”, or “physical channel for R2D (data/control) transmission”.

Throughout the present disclosure, the “PDSCH” may be replaced by “PRDCH”, “downlink shared channel”, or “PDSCH for ambient IoT”, or “physical channel for R2D (data/control) transmission”.

Throughout the present disclosure, the “BWP” may be replaced by “system bandwidth”, “channel bandwidth”, “transmission bandwidth”, “occupation bandwidth”, “sub-band of/in a cell”, or “subset of the total cell bandwidth of a cell”.

Throughout the present disclosure, the “RACH” may be replaced by “PDRCH”, “access channel”, or “RACH for ambient IoT”.

Throughout the present disclosure, the “cell” may be replaced by “intermediate node”.

Throughout the present disclosure, the network (node) may be changed/represented/replaced as intermediate node.

Throughout the present disclosure, the “time duration” may be replaced by “time period”.

Throughout the present disclosure, the “CCCH message” may be replaced by “CCCH SDU”.

Throughout the present disclosure, the “PDRCH” may be replaced by “physical channel for D2R (data) transmission”.

Throughout the present disclosure, the “PRDCH” may be replaced by “physical channel for R2D (data) transmission”.

Throughout the present disclosure, the (data and/or signaling) transmission from reader to device/UE may be via PRDCH. Throughout the present disclosure, the (data and/or signaling) transmission from device/UE to reader may be via PDRCH.

Throughout the present disclosure, the “downlink control information” may be replaced by R2D control information.

Throughout the present disclosure, the “uplink control information” may be replaced by D2R control information.

Throughout the present disclosure, the downlink control information may be transmitted via PRDCH or R2D command.

The UE may be referred to as the UE, an RRC layer of the UE, a MAC entity of the UE, or physical layer of the UE.

Throughout the present disclosure, the UE may be an ambient IoT device/UE. The UE may be a device used for ambient IoT. The UE may be a device capable of ambient IoT. The UE may be an NR device. The UE may be a Long Term Evolution (LTE) device. The UE may be an IoT device. The UE may be a wearable device. The UE may be a sensor. The UE may be a stationary device. The UE may be a tag. Throughout the present disclosure, the following may be interchangeable: (ambient IoT) UE, (ambient IoT) device.

The UE may not be a legacy UE. The legacy UE may be a non-ambient IoT device/UE. The legacy UE may perform different (RA and/or initial access) procedures from the ambient IoT UE. The UE may be a legacy UE with capability to perform ambient IoT procedure. Throughout the present disclosure, the following may be interchangeable: normal UE, legacy UE. The ambient IoT UE may have capability of ambient IoT. The legacy UE may or may not have capability of ambient IoT procedure.

The network may be a network node. The network (node) may be a base station. The network (node) may be an access point. The network (node) may be an Evolved Node B (eNB). The network (node) may be a Next Generation Node B (gNB). The network (node) may be a gateway.

Various examples and embodiments of the present invention are described below. For the methods, alternatives, concepts, examples, and embodiments detailed above and herein, the following aspects and embodiments are possible.

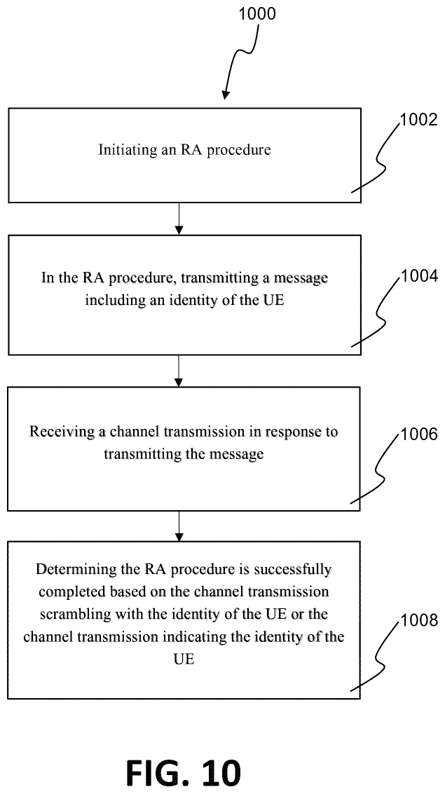

Referring to FIG. 10, with this and other concepts, systems, and methods of the present invention, a method 1000 for a UE in a wireless communication system comprises initiating an RA procedure (step 1002), in the RA procedure, transmitting a message including an identity of the UE (step 1004), receiving a channel transmission in response to transmitting the message (step 1006), and determining the RA procedure is successfully completed based on the channel transmission scrambling with the identity of the UE or the channel transmission indicating the identity of the UE (step 1008).

In various embodiments, the UE is an ambient IoT device.

In various embodiments, the message is a Msg1, Msg3 or a MSGA.

In various embodiments, the message does not include a CCCH message and/or a C-RNTI.

In various embodiments, the identity of the UE is ue-Identity and/or a UE contention resolution ID provided in a MAC CE.

In various embodiments, the identity of the UE is provided in a MAC CE or is a MAC CE.

In various embodiments, the channel transmission is addressed to a TC-RNTI or a MSGB-RNTI.

In various embodiments, the TC-RNTI is provided in an RAR or a MSGB from the NW.

In various embodiments, the MSGB-RNTI is calculated by the UE.

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) initiate an RA procedure; (ii) in the RA procedure, transmit a message including an identity of the UE; (iii) receive a channel transmission in response to transmitting the message; and (iv) determine the RA procedure is successfully completed based on the channel transmission scrambling with the identity of the UE or the channel transmission indicating the identity of the UE. Moreover, the CPU 308 can execute the program code 312 to perform all of the described actions, steps, and methods described above, below, or otherwise herein.

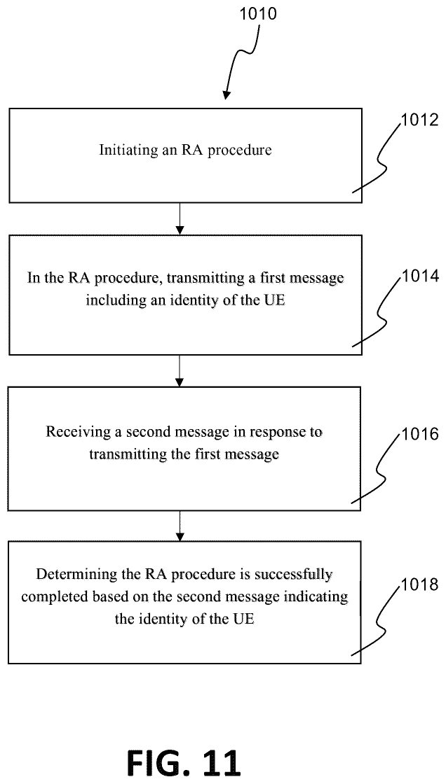

Referring to FIG. 11, with this and other concepts, systems, and methods of the present invention, a method 1010 for a UE in a wireless communication system comprises initiating an RA procedure (step 1012), in the RA procedure, transmitting a first message including an identity of the UE (step 1014), receiving a second message in response to transmitting the first message (step 1016), and determining the RA procedure is successfully completed based on the second message indicating or comprising the identity of the UE (step 1018).

In various embodiments, the UE is an ambient IoT device.

In various embodiments, the UE initiates the RA procedure in response to (receiving) a first signaling, e.g., a paging for ambient IoT.

In various embodiments, the first message is a Msg1, Msg3 or a MSGA.

In various embodiments, the first message does not include a CCCH message and/or a C-RNTI.

In various embodiments, the identity of the UE is a random number (e.g., generated by the UE), ue-Identity and/or a UE contention resolution ID provided in a MAC CE.

In various embodiments, the identity of the UE is provided in a MAC CE or is a MAC CE.

In various embodiments, the second message is via a PDSCH transmission or a PRDCH transmission.

In various embodiments, the second message is via a response to the first message.

In various embodiments, the second message is a Msg4 or MSGB.

In various embodiments, the second message comprises a UE contention resolution ID MAC CE.

In various embodiments, the UE contention resolution ID MAC CE matches the identity of the UE.

In various embodiments, the second message does not comprise or indicate a Timing Advance Command (TAC), C-RNTI, ChannelAccess-CPext, Transmitter Power Control (TPC) command, indication for Hybrid Automatic Repeat Request (HARQ) feedback, and/or indication for PUCCH resource.

In various embodiments, the UE does not apply a Timing Advance (TA) value in response to (receiving) the second message.

In various embodiments, the UE does not set a C-RNTI in response to (receiving) the second message.

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) initiate an RA procedure; (ii) in the RA procedure, transmit a first message including an identity of the UE; (iii) receive a second message in response to transmitting the first message; and (iv) determine the RA procedure is successfully completed based on the second message indicating or comprising the identity of the UE. Moreover, the CPU 308 can execute the program code 312 to perform all of the described actions, steps, and methods described above, below, or otherwise herein.

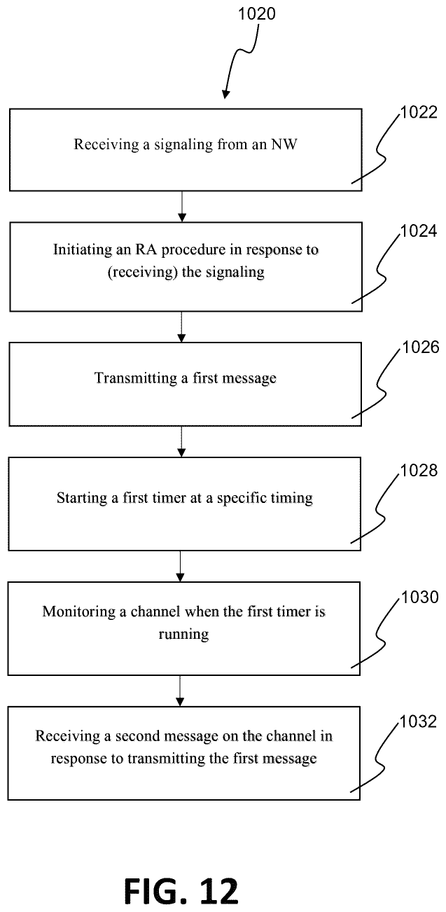

Referring to FIG. 12, with this and other concepts, systems, and methods of the present invention, a method 1020 for a UE in a wireless communication system comprises receiving a signaling from an NW (step 1022), initiating an RA procedure in response to (receiving) the signaling (step 1024), transmitting a first message (step 1026), starting a first timer at a specific timing (step 1028), monitoring a channel when the first timer is running (step 1030), and receiving a second message on the channel in response to transmitting the first message (step 1032).

In various embodiments, the UE is an ambient IoT device.

In various embodiments, the signaling is a carrier wave and/or an interrogation signal for ambient IoT.

In various embodiments, the first message is a Msg1, Msg3, or a MSGA.

In various embodiments, the first timer is an RA response window, MSGB response window, or a contention resolution timer.

In various embodiments, the specific timing is the end of the first transmission plus a time offset, the end of the signaling reception plus a time offset, or arrival time of another signaling.

In various embodiments, the second message is a Msg2, Msg4, or a MSGB.

In various embodiments, the time offset is related to characteristic of the UE.

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) receive a signaling from an NW; (ii) initiate an RA procedure in response to (receiving) the signaling; (iii) transmit a first message; (iv) start a first timer at a specific timing; (v) monitor a channel when the first timer is running; and (vi) receive a second message on the channel in response to transmitting the first message. Moreover, the CPU 308 can execute the program code 312 to perform all of the described actions, steps, and methods described above, below, or otherwise herein.

Referring back to FIGS. 3 and 4, in one or more embodiments from the perspective of an NW in a wireless communication system, the device 300 includes a program code 312 stored in memory 310 of the transmitter. The CPU 308 could execute program code 312 to: (i) transmit a signaling to a UE; (ii) receive a first message from the UE; (iii) transmit a second message on a channel, to the UE, in response to receiving the first message. Moreover, the CPU 308 can execute the program code 312 to perform all of the described actions, steps, and methods described above, below, or otherwise herein.

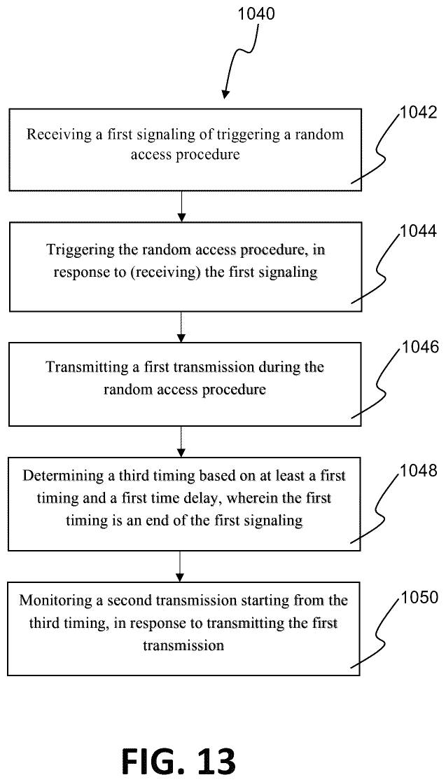

Referring to FIG. 13, with this and other concepts, systems, and methods of the present invention, a method 1040 for a UE in a wireless communication system comprises receiving a first signaling of triggering a random access procedure (step 1042), triggering the random access procedure, in response to (receiving) the first signaling (step 1044), transmitting a first transmission during the random access procedure (step 1046), determining a third timing based on at least a first timing and a first time delay, wherein the first timing is an end of the first signaling (step 1048), and monitoring a second transmission starting from the third timing, in response to transmitting the first transmission (step 1050).

In various embodiments, the first time delay is at least one of: a pre-defined value, indicated by a network, derived or calculated by the UE, and/or derived or calculated by the UE based on at least an indication provided by the first signaling and/or the pre-defined value.

In various embodiments, the first time delay is a pre-defined value or is indicated by a network.

In various embodiments, the first time delay is derived or calculated by the UE, e.g., based on at least an indication provided by the first signaling and/or the pre-defined value.

In various embodiments, the first signaling is a paging for ambient IoT.

In various embodiments, the first signaling is for more than one UE.

In various embodiments, the first signaling triggers and/or indicates the more than one UE to perform the random access procedure.

In various embodiments, the first signaling indicates at least a resource of the first transmission.

In various embodiments, the third timing is common for the more than one UE.

In various embodiments, the third timing is a start time for monitoring the second transmission.

In various embodiments, the third timing is determined based on at least the first timing plus the first time delay, and/or the third timing is after the first timing plus the first time delay.

In various embodiments, the first timing is the last occasion of the first signaling.

In various embodiments, the first timing is the first occasion after the end of the first signaling.

In various embodiments, the first signaling and/or the second transmission is received from a reader.

In various embodiments, the first transmission is transmitted to the reader.

In various embodiments, the reader is a network or another UE.

In various embodiments, the UE receives the second transmission after the third timing.

In various embodiments, the first transmission comprises at least an ID of the UE, e.g., a random ID.

In various embodiments, the second transmission comprises at least the ID of the UE.

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) receive a first signaling of triggering a random access procedure; (ii) trigger the random access procedure, in response to (receiving) the first signaling; (iii) transmit a first transmission during the random access procedure; (iv) determine a third timing based on at least a first timing and a first time delay, wherein the first timing is an end of the first signaling; and (v) monitor a second transmission starting from the third timing, in response to transmitting the first transmission. Moreover, the CPU 308 can execute the program code 312 to perform all of the described actions, steps, and methods described above, below, or otherwise herein.

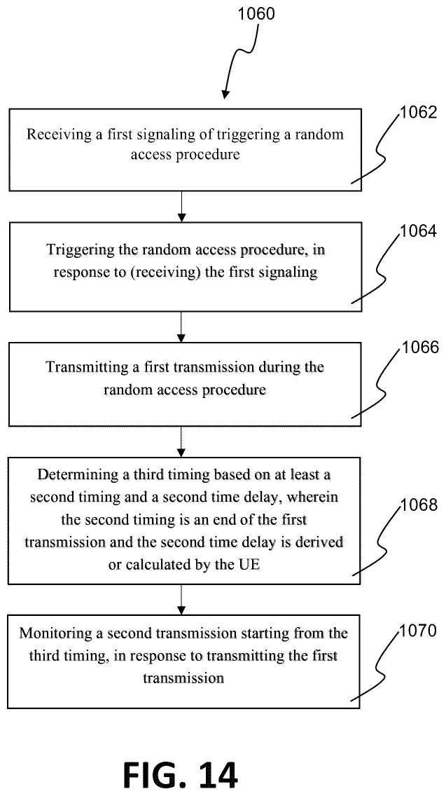

Referring to FIG. 14, with this and other concepts, systems, and methods of the present invention, a method 1060 for a UE in a wireless communication system comprises receiving a first signaling of triggering a random access procedure (step 1062), triggering the random access procedure, in response to (receiving) the first signaling (step 1064), transmitting a first transmission during the random access procedure (step 1066), determining a third timing based on at least a second timing and a second time delay, wherein the second timing is an end of the first transmission and the second time delay is derived or calculated by the UE (step 1068), and monitoring a second transmission starting from the third timing, in response to transmitting the first transmission (step 1070).

In various embodiments, the second time delay is derived or calculated (e.g., by the UE) based on at least an indication provided by the first signaling and/or a pre-defined value.

In various embodiments, the second time delay is derived or calculated (e.g., by the UE) based on a time association between the first transmission and the second transmission.

In various embodiments, the first signaling is a paging for ambient IoT.

In various embodiments, the first signaling is for more than one UE.

In various embodiments, the first signaling indicates at least a resource of the first transmission.

In various embodiments, the third timing is common for the more than one UE.

In various embodiments, the third timing is a start time for monitoring the second transmission.

In various embodiments, the third timing is determined based on at least the second timing plus the second time delay, and/or the third timing is after the second timing plus the second time delay.

In various embodiments, the second timing is the last occasion of the first transmission.

In various embodiments, the second timing is the first occasion after the end of the first transmission.

In various embodiments, the first signaling and/or the second transmission is received from a reader.

In various embodiments, the first transmission is transmitted to the reader.

In various embodiments, the reader is a network or another UE.

In various embodiments, the UE receives the second transmission after the third timing.

In various embodiments, the first transmission comprises at least an ID of the UE, e.g., a random ID.

In various embodiments, the second transmission comprises at least the ID of the UE.

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) receive a first signaling of triggering a random access procedure; (ii) trigger the random access procedure, in response to (receiving) the first signaling; (iii) transmit a first transmission during the random access procedure; (iv) determine a third timing based on at least a second timing and a second time delay, wherein the second timing is an end of the first transmission and the second time delay is derived or calculated by the UE; and (v) monitor a second transmission starting from the third timing, in response to transmitting the first transmission. Moreover, the CPU 308 can execute the program code 312 to perform all of the described actions, steps, and methods described above, below, or otherwise herein.

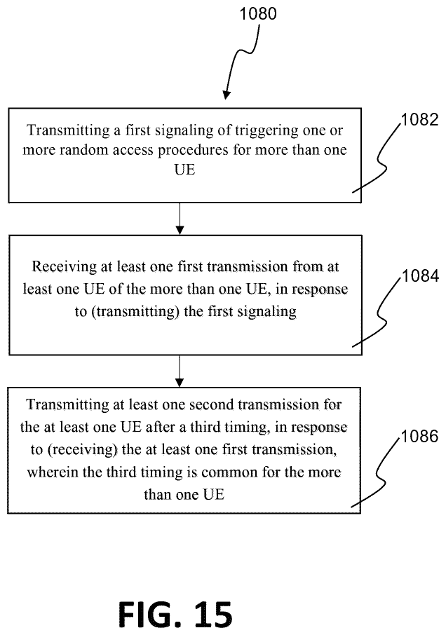

Referring to FIG. 15, with this and other concepts, systems, and methods of the present invention, a method 1080 for a reader in a wireless communication system comprises transmitting a first signaling of triggering one or more random access procedures for more than one UE (step 1082), receiving at least one first transmission from at least one UE of the more than one UE, in response to (transmitting) the first signaling (step 1084), and transmitting at least one second transmission for the at least the one UE after or upon a third timing, in response to (receiving) the at least one first transmission, wherein the third timing is common for the more than one UE (step 1086).

In various embodiments, the third timing is determined based on at least a first timing and a first time delay, wherein the first timing is an end of the first signaling.

In various embodiments, the first timing is the last occasion of the first signaling.

In various embodiments, the first timing is the first occasion after the end of the first signaling.

In various embodiments, the first time delay is at least one of: a pre-defined value, indicated by the reader, and/or derived or calculated by the reader based on at least an indication provided in the first signaling and/or a pre-defined value.

In various embodiments, the first time delay is a pre-defined value or is indicated by the reader.

In various embodiments, the first time delay is derived or calculated by the UE, e.g., based on at least an indication provided by the first signaling and/or the pre-defined value.

In various embodiments, the third timing is determined based on at least the first timing plus the first time delay, and/or the third timing is after the first timing plus the first time delay.

In various embodiments, the third timing is a start time for transmitting the at least one second transmission.

In various embodiments, the first signaling is a paging for ambient IoT.

In various embodiments, the first signaling triggers and/or indicates the more than one UE to perform the random access procedure.

In various embodiments, the first signaling indicates at least one or more resources of the at least one first transmission.

In various embodiments, the reader is a network or another UE.

In various embodiments, the at least one first transmission comprises at least an ID of the UE, e.g., a random ID.

In various embodiments, the at least one second transmission comprises at least the ID of the UE.

Referring back to FIGS. 3 and 4, in one or more embodiments from the perspective of a reader in a wireless communication system, the device 300 includes a program code 312 stored in memory 310 of the transmitter. The CPU 308 could execute program code 312 to: (i) transmit a first signaling of triggering one or more random access procedures for more than one UE; (ii) receive at least one first transmission from at least one UE of the more than one UE, in response to (transmitting) the first signaling; and (iii) transmit at least one second transmission for the at least the one UE after or upon a third timing, in response to (receiving) the at least one first transmission, wherein the third timing is common for the more than one UE. Moreover, the CPU 308 can execute the program code 312 to perform all of the described actions, steps, and methods described above, below, or otherwise herein.

Any combination of the above or herein concepts or teachings can be jointly combined, in whole or in part, or formed to a new embodiment. The disclosed details and embodiments can be used to solve at least (but not limited to) the issues mentioned above and herein.

It is noted that any of the methods, alternatives, steps, examples, and embodiments proposed herein may be applied independently, individually, and/or with multiple methods, alternatives, steps, examples, and embodiments combined together.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects, concurrent channels may be established based on pulse repetition frequencies. In some aspects, concurrent channels may be established based on pulse position or offsets. In some aspects, concurrent channels may be established based on time hopping sequences. In some aspects, concurrent channels may be established based on pulse repetition frequencies, pulse positions or offsets, and time hopping sequences.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of ordinary skill in the art would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer program product may comprise packaging materials.

While the invention has been described in connection with various aspects and examples, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method of a User Equipment (UE), comprising:
receiving a first signaling of triggering a random access procedure;
triggering the random access procedure, in response to the first signaling;
transmitting a first transmission during the random access procedure;
determining a third timing based on at least a first timing and a first time delay, wherein the first timing is an end of the first signaling; and
monitoring a second transmission starting from the third timing, in response to transmitting the first transmission.

2. The method of claim 1, wherein the first time delay is at least one of:
a pre-defined value,
indicated by a network,
derived or calculated by the UE, or
derived or calculated by the UE based on at least an indication provided by the first signaling and/or the pre-defined value.

3. The method of claim 1, wherein:
the first signaling is a paging for ambient Internet of Things (IoT), and/or
the first signaling is for more than one UE, and/or
the first signaling indicates at least a resource of the first transmission.

4. The method of claim 1, wherein the third timing is common for more than one UE, and/or the third timing is a start time for monitoring the second transmission.

5. The method of claim 1, wherein the third timing is determined based on at least the first timing plus the first time delay, and/or the third timing is after the first timing plus the first time delay.

6. The method of claim 1, wherein the first signaling and/or the second transmission is received from a reader, and/or the first transmission is transmitted to the reader, wherein the reader is a network or another UE.

7. A method of a User Equipment (UE), comprising:
receiving a first signaling of triggering a random access procedure;
triggering the random access procedure, in response to the first signaling;
transmitting a first transmission during the random access procedure;
determining a third timing based on at least a second timing and a second time delay, wherein the second timing is an end of the first transmission and the second time delay is derived or calculated by the UE; and
monitoring a second transmission starting from the third timing, in response to transmitting the first transmission.

8. The method of claim 7, wherein the second time delay is derived or calculated based on at least an indication provided by the first signaling and/or a pre-defined value, and/or the second time delay is derived or calculated based on a time association between the first transmission and the second transmission.

9. The method of claim 7, wherein:
the first signaling is a paging for ambient Internet of Things (IoT), and/or
the first signaling is for more than one UE, and/or
the first signaling indicates at least a resource of the first transmission.

10. The method of claim 7, wherein the third timing is common for more than one UE, and/or the third timing is a start time for monitoring the second transmission.

11. The method of claim 7, wherein the third timing is determined based on at least the second timing plus the second time delay, and/or the third timing is after the second timing plus the second time delay.

12. The method of claim 7, wherein the first signaling and/or the second transmission is received from a reader, and/or the first transmission is transmitted to the reader, wherein the reader is a network or another UE.

13. A method of a reader, comprising:
transmitting a first signaling of triggering one or more random access procedures for more than one User Equipment (UE);
receiving at least one first transmission from at least one UE of the more than one UE, in response to the first signaling; and
transmitting at least one second transmission for the at least one UE after a third timing, in response to the at least one first transmission, wherein the third timing is common for the more than one UE.

14. The method of claim 13, wherein the third timing is determined based on at least a first timing and a first time delay, wherein the first timing is an end of the first signaling.

15. The method of claim 14, wherein the first time delay is at least one of:
a pre-defined value,
indicated by the reader, or
derived or calculated by the reader based on at least an indication provided in the first signaling and/or the pre-defined value.

16. The method of claim 14, wherein the third timing is determined based on at least the first timing plus the first time delay, and/or the third timing is after the first timing plus the first time delay.

17. The method of claim 13, wherein the first signaling is a paging for ambient Internet of Things (IoT), and/or the first signaling indicates at least one or more resources of the at least one first transmission.

18. The method of claim 13, wherein the reader is a network or another UE.

19. The method of claim 13, wherein the at least one first transmission comprises at least an Identity (ID) of the at least one UE.

20. The method of claim 13, wherein the at least one second transmission comprises at least an ID of the at least one UE.
